(19) United States
(12) Patent Application Publication
(10) Pub. No.: US 2009/0323689 A1
(43) Pub. Date: Dec. 31, 2009

(54) EDGE SWITCH AND FORWARDING TABLE REWRITING METHOD

(75) Inventor: Masahiro Saito, Kawasaki-shi (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/554,573

(22) Filed: Sep. 4, 2009

Related U.S. Application Data
(63) Continuation of application No. PCT/JP2007/000220, filed on Mar. 14, 2007.

(51) Int. Cl. H04L 12/56

(52) U.S. Cl. 370/390; 370/401

(57) ABSTRACT

An edge switch that switches a frame between a user network and a wide area network includes an access port to connect a communication module including a storage unit storing a first identification number identifying which access port the communication module is connected to; an identification number storage unit storing a second identification number assigned to the access port; a control circuit capable of detecting a connection of the communication module; a reading unit to read the first identification number upon detection of the connection; a switchover determination unit to read the second identification number of the access port to which the connection has been detected, to compare the second and first identification numbers, and to determine that a switchover has occurred if they do not match; and a writing unit to write to the storage unit the second identification number when the switchover is determined to have occurred.

### CROSS-REFERENCE TO RELATED APPLICATIONS

This application is a continuation of PCT application PCT/JP2007/000220, which was filed on Mar. 14, 2007, and the entire contents of which are incorporated herein by reference.

### FIELD

The present invention relates to a wide area network (WAN) service using a transit network (i.e., wide area network) for connecting user networks, and more specifically to an edge switch and rewrite method of its forwarding table in a wide area network.

### BACKGROUND

In a certain wide area network such as a wide area Ethernet using an “Ethernet over Ethernet” system, an edge switch accommodating user networks to connect them to a wide area network forwards a communication frame using a forwarding table for which the correspondence between a network port on the WAN side and the destination address of a communication frame has been learned.

In addition, there has been an increasing use of a wide area Ethernet service for connecting geographically separate LANs (local area networks) by an Ethernet interface because an enterprise network connecting a plurality of locations is enabled to provide a connection as if the connection were made in a LAN, and because the wide area Ethernet service is advantageous in cost over the utilization of a leased line.

A wide area Ethernet service is realized by a wide area network provided by a carrier or a provider. A wide area network is configured by edge switches for accommodating user networks and a core switch (or core switches) for forming a transmission path between edge switches. Hereinafter an edge switch and a core switch can be collectively referred to simply as switches. Each switch has a forwarding table in order to forward a communication frame (which can be hereinafter referred to simply as a frame) depending on its destination. The forwarding table stores forwarding route information about a frame, and the forwarding route information indicates the correspondence between the destination of the frame and the port of a switch for transmitting the frame.

The forwarding route information about the frame is written to the forwarding table as a consequence of recognizing the port through which the frame transmitted from a source has been input, and learning that a frame addressed to the source is to be transmitted from the port.

One of the system of data forwarding in the wide area Ethernet service using the forwarding table as mentioned above can be a Ethernet over Ethernet system (hereinafter referred to as an EoE system).

In an aspect of the EoE system, each access port on the user network side of an edge switch in a wide area network is assigned a unique EoE MAC (media access control) address for identification of the access port and a VPN-ID (virtual private network identifier) for identification of a user network accommodated in the access port. An edge switch encapsulates a user frame received at an access port using the EoE MAC address and the VPN-ID, and transmits the encapsulated user frame to a core switch.

A core switch in the wide area network forwards the frame using the VPN-ID and the EoE MAC address added by the edge switch. The core switch can be a normal switch capable of recognizing a VLAN (virtual local area network) tag (in other words, the core switch can be a switch equivalent to a core switch used in a wide area network in a extended tagged VLAN system which is a forwarding system different from the EoE system). When the frame is received by another edge switch connected to a destination user network, the added VPN-ID and the EoE MAC address are removed from the frame, and the frame thus decapsulated is forwarded to the user network.

The EoE MAC address for identification of the access port and the VPN-ID, both added at the edge switch, are learned at the core switch.

FIG. 1 illustrates an example of a forwarding table of an edge switch. A forwarding table 15 illustrated in FIG. 1 includes a key portion and a contents portion. The key portion is configured by a VPN-ID, a VLAN, and a MAC address of a user device accommodated in a user network. The contents portion is configured by an EoE MAC address, and a port (i.e., network port). FIG. 1 illustrates that the value “500” of the VPN-ID, the value “300” of the VLAN, and the value “20” of the MAC address are stored as keys, and that the value “222” of the EoE MAC address and the value “P2” of the network port are stored as contents. A VLAN in FIG. 1 indicates a VLAN group to which a user device belongs.

When a table is searched, an destination MAC address and a VLAN value in a user frame, and a VPN-ID value in a transit network are used as search keys. During learning, a source MAC address and a VLAN value in a user frame, and a VPN-ID value in a transit network are used as search keys.

FIG. 2 is an explanatory view of frame forwarding in the EoE system using the forwarding table illustrated in FIG. 1. In the example illustrated in FIG. 2, a frame is forwarded from a user device 13a having a MAC address “10” in a user network 12a to a user device 13b having a MAC address “20” in a user network 12b through a transit network 10 as a wide area network.

In the example illustrated in FIG. 2, both user devices 13a and 13b belong to a VLAN to which “300” is assigned as a VLAN value in a user network to which “500” is assigned as a VPN-ID value. That is, the user networks 12a and 12b virtually forms the same network; and for example, the user networks 12a and 12b can be respective local area networks in branch offices located in different locations in the same enterprise. The user device 13a and the user device 13b belong to the same VLAN group in the above-mentioned same user network.

As illustrated in FIG. 2, the user device 13a transmits, to a first edge switch 14a (refereed to as “Edge SW1” in the drawings), a frame that includes the header including the source MAC address “10”, the destination MAC address “20”, and the VLAN value “300”, and the payload. The user network 12a is connected to an access port which is of the first edge switch 14a and to which “500” as a VPN-ID value and “111” as an EoE MAC address are assigned.

The first edge switch 14a, which receives the frame from the user network 12a, searches a forwarding table 15a for an entry by using as search keys the destination MAC address “20” and the VLAN value “300” in the user frame, and the VPN-ID value “500” in the transit network 10. In the example illustrated in FIG. 2, there is an entry that is searched for, and “222” as the destination EoE MAC address of the EoE frame, and the network port “P2” as the output port of the first edge switch's own are read. The first edge switch 14a encapsulates the received user frame using “222” as a destination EoE MAC address (DA), “111” as a source EoE MAC address (SA), and “500” as a VPN-ID value, and outputs the EoE frame from the network port P2 to the transit network 10.

In the transit network 10, a frame is forwarded using the EoE-encapsulated destination MAC address and VPN-ID value.

A second edge switch 14b (refereed to as “Edge SW2” in the drawings) that receives the EoE frame learns a network port P1 that has received the frame and a source EoE MAC address “111” of the EoE frame using the source MAC address “10” and the VLAN value “300” in the user frame, and the VPN-ID value “500” in the transit network 10 as keys. That is, in a forwarding table 15b of the second edge switch 14b, an entry is generated that includes the VPN-ID value “500”, the VLAN value “300”, and the MAC address “10” as keys, and that includes the EoE MAC address “111” and the network port “P1” as contents.

At the second edge switch 14b, the information added at the first edge switch 14a is removed from the EoE frame to restore the original user frame, and the original user frame is transmitted to the user network 12b.

Next, the switchover of a user network in the above-mentioned EoE system is described below with reference to the EoE system in which the edge switches operate in the redundant device configuration.

FIG. 3 is an explanatory view of the redundant configuration with edge switches. FIG. 4 is an explanatory view of the switchover between access ports in the redundant configuration.

Assume that an active edge switch 14 and a standby edge switch 14′ are connected to the wide area network 10, and a user network 12 is connected to an access port of the active edge switch 14. Frames are forwarded between the wide area network 10 and the user network 12 through the access port of the active edge switch 14.

As illustrated in FIG. 4, if the user network 12 is switched over to an access port of the standby edge switch 14′, frames in the direction from the user network 12 to the wide area network 10 will be forwarded through the standby edge switch 14′, but frames in the direction from the wide area network 10 to the user network 12 will be forwarded to a wrong destination, that is, the access port that has been used until the switchover. Such wrong forwarding will continue and frames will not be transmitted to their desired destinations until the re-learning is performed by the switch in the wide area network 10.

Frames will be transmitted to their correct destinations after a forwarding table is re-learned as a consequence of multicasting frames and receiving frames that reply to the multicast frames. Such multicasting is performed because the learned contents are erased with the lapse of aging time or because of a frame not arrived at its destination. Therefore, time is required to correctly transmit the frames addressed to a switched-over user network.

To avoid the above-mentioned problem, the learned contents in the forwarding table of the switch in the wide area network 10 can be erased or rewritten when the user network 12 is switched over.

Since the EoE MAC address used in the wide area network 10 is managed by an administrator of the wide area network 10 in the EoE system, a target to be erased or rewritten in the learned contents, and a value that the target is to be rewritten to can be specified. Therefore, the learned contents can be erased or rewritten on a target switch by operating a control terminal etc.

However, if the learned contents are erased or rewritten incorrectly, a network suffers great influence. Therefore, it is desirable that the learned contents are erased or rewritten not by an operation of a control terminal but by automatically setting a forwarding table in response to a switchover.

The patent documents 1 and 2 listed below disclose the technology related to the above-mentioned switchover of a user network.

For example, a management terminal connected to a trunk line LAN may monitor a bridge between the trunk line LAN and a branch line LAN by polling etc. The management terminal, upon detection of a fault of the bridge, may issue a command to activate a standby bridge and may transmit a fault occurrence notification including the addresses of the faulty bridge and the switching bridge to all bridges.

There is also a technology for transmitting and receiving a health check message between adjacent communication stations, and communicating a route information notification in a network on the basis of the health check message, thereby updating a learning table used in routing communication data.

Patent Document 1: Japanese Laid-open Patent Publication No. H03-101435

Patent Document 2: Japanese Laid-open Patent Publication No. 2000-278309

### SUMMARY

An edge switch that switches a communication frame between a user network and a wide area network is provided. The edge switch includes an access port, a identification number storage unit, a control circuit for the access port, an identification number reading unit, a switchover determination unit, and an identification number writing unit.

The access port is configured to connect a communication module that is of the user network and that includes a storage unit configured to store a first identification number identifying which access port the communication module is connected to. The identification number storage unit is configured to store a second identification number assigned to the access port.

The control circuit includes a detecting unit configured to detect a connection of the communication module to the access port. The identification number reading unit is configured to read the first identification number recorded in the storage unit of the communication module upon the control circuit detecting the connection of the communication module to the access port.

The switchover determination unit is configured to read from the identification number storage unit the second identification number of the access port to which the connection of the communication module has been detected. It is also configured to compare the second identification number with the first identification number read by the identification number reading unit. It is further configured to determine that a switchover of the communication module has occurred if the compared first and second identification numbers do not match each other.

The identification number writing unit is configured to write to the storage unit of the communication module the second identification number read from the identification number storage unit when the switchover determination unit determines that the switchover of the communication module has occurred.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates a forwarding table of an edge switch;

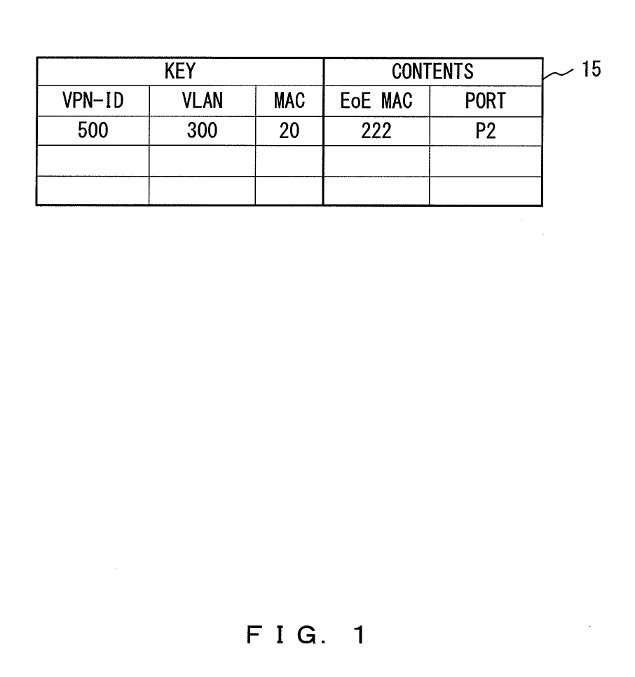

FIG. 2 is an explanatory view of forwarding an EoE frame;

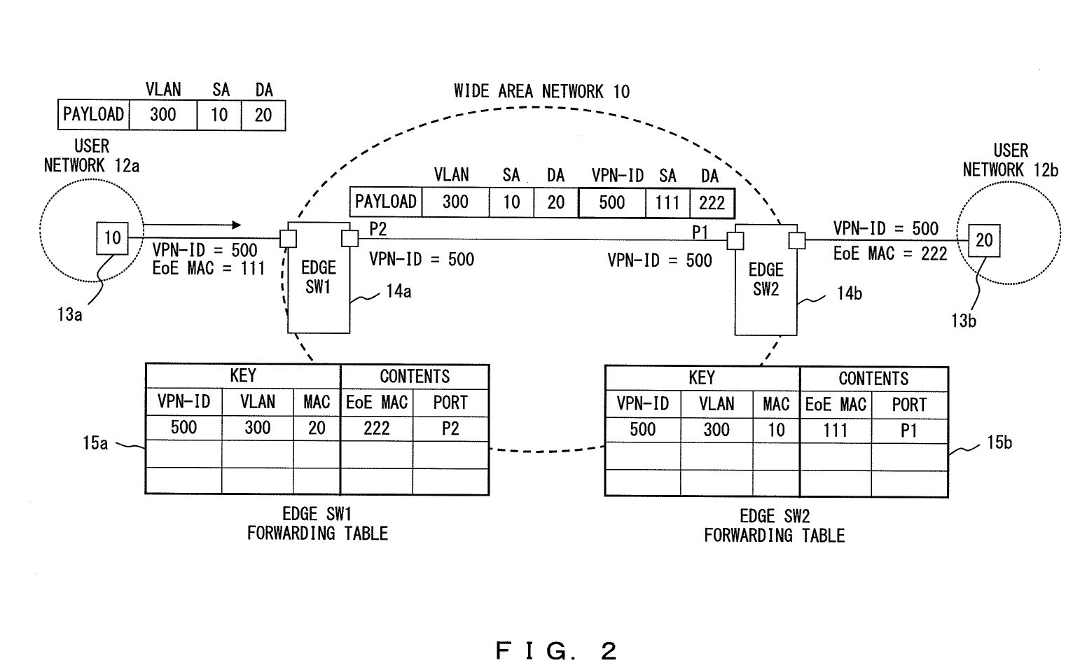

FIG. 3 is an explanatory view of the redundant configuration with edge switches;

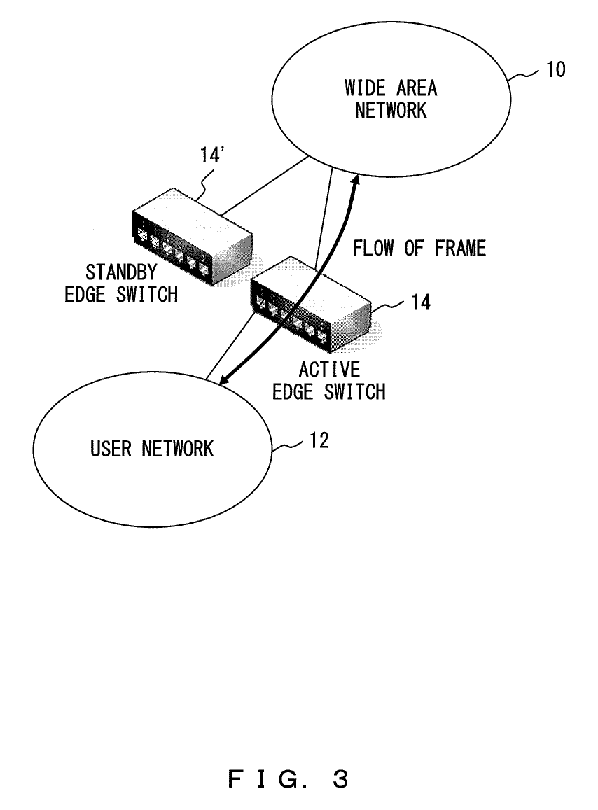

FIG. 4 is an explanatory view of a switchover between access ports in a redundant configuration;

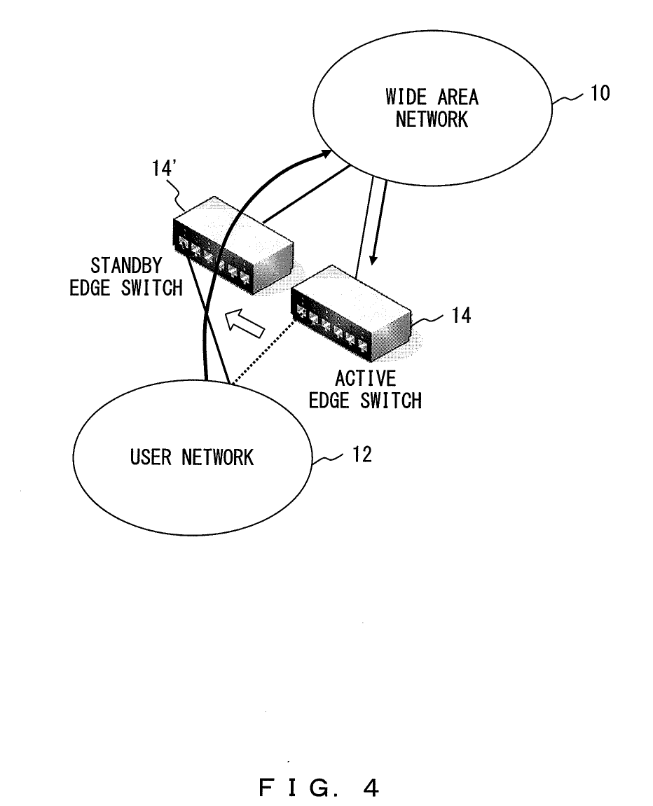

FIG. 5A illustrates an example of the configuration of the edge switch according to the first embodiment;

FIG. 5B is an explanatory view of the operation sequence of the edge switch according to the first embodiment;

FIG. 5C is an explanatory view of the flow of the communication module switching-over process in an edge switch according to the first embodiment;

FIG. 6A illustrates an example of the configuration of the edge switch according to the second embodiment;

FIG. 6B is an explanatory view of the operation sequence of the edge switch according to the second embodiment;

FIG. 7A illustrates an example of the configuration of the edge switch according to the third embodiment;

FIG. 7B is an explanatory view of the operation sequence of the edge switch according to the third embodiment;

FIG. 8A illustrates an example of the configuration of the edge switch according to the fourth embodiment;

FIG. 8B is an explanatory view of the operation sequence of the edge switch according to the fourth embodiment;

FIG. 9A illustrates an example of the configuration of the edge switch according to the fifth embodiment;

FIG. 9B is an explanatory view of the flow of the communication module switching-over process performed by the control circuit according to the fifth embodiment;

FIG. 10 illustrates an example of the configuration of the edge switch according to the sixth embodiment;

FIG. 11A is an explanatory view of the operation of the transmitting edge switch according to the seventh embodiment;

FIG. 11B is an explanatory view of the operation of the receiving edge switch according to the seventh embodiment;

FIG. 11C is an explanatory view of the operation sequence between the switches according to the seventh embodiment;

FIG. 11D is an explanatory view of the influence on other access ports when a switchover occurs;

FIG. 12A is an explanatory view of the operation of the transmitting edge switch according to the eighth embodiment;

FIG. 12B is an explanatory view of the configuration of the control multicast frame according to the eighth embodiment;

FIG. 12C is an explanatory view of the operation of the receiving edge switch according to the eighth embodiment;

FIG. 12D is an explanatory view of the operation sequence between the switches according to the eighth embodiment;

FIG. 13A is an explanatory view of the configuration of the control multicast frame according to the ninth embodiment;

FIG. 13B is an explanatory view of the operation sequence between the switches according to the ninth embodiment;

FIG. 14A illustrates an example of the configuration of the network using switches according to an embodiment;

FIG. 14B illustrates the configuration after a switchover of a user network in an example of the network configuration illustrated in FIG. 14A; and

FIG. 14C illustrates a result of rewriting each forwarding table triggered by the switchover of the user network illustrated in FIG. 14B.

### DESCRIPTION OF EMBODIMENTS

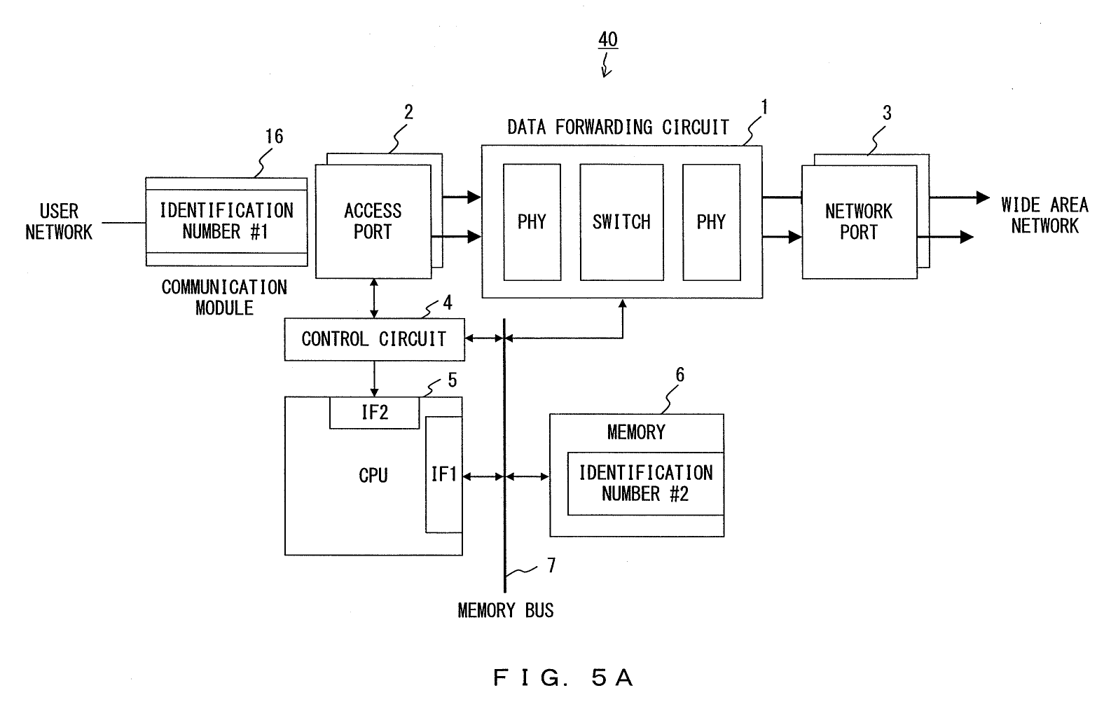

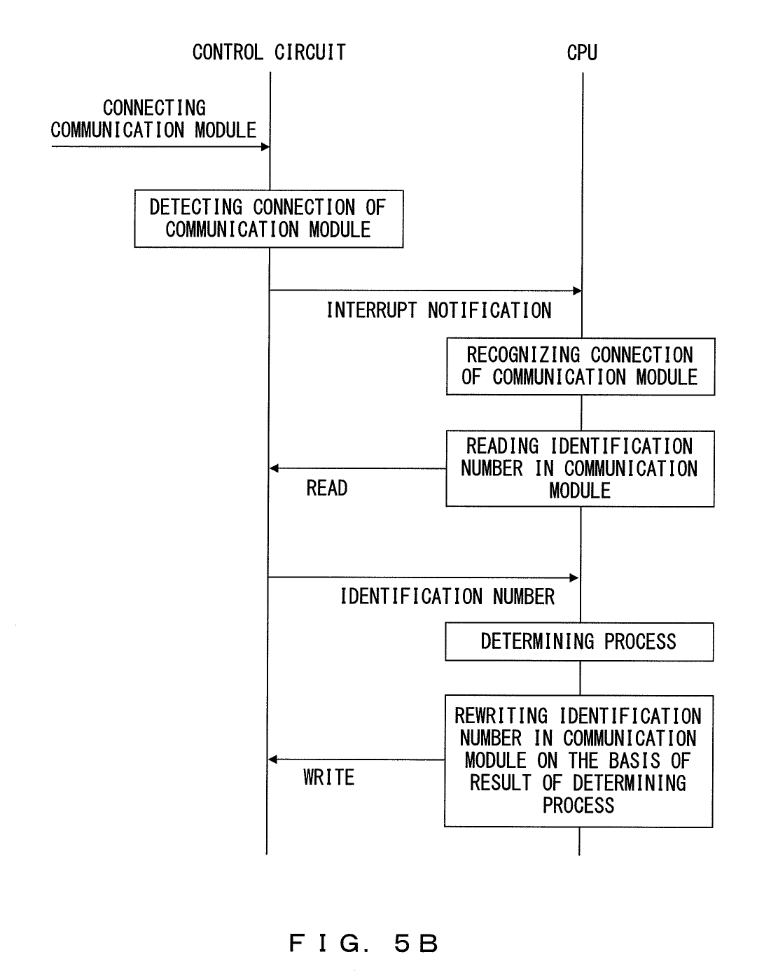

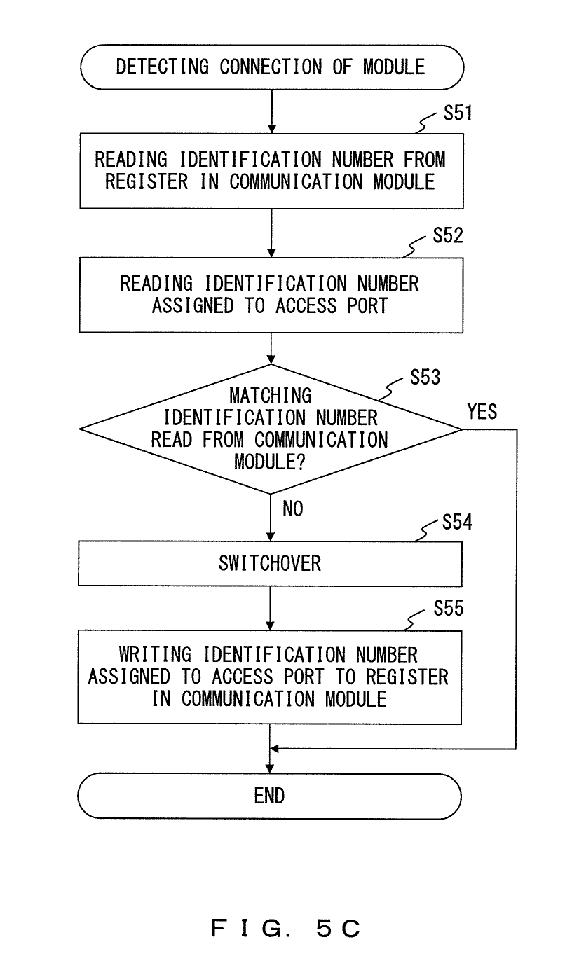

The first embodiment is described first with reference to FIGS. 5A through 5C. In the first embodiment, when a control circuit for controlling the access port of an edge switch detects that a communication module is connected to the access port, it issues an interrupt notification to the CPU (central processing unit) managing and controlling the edge switch.

FIG. 5A illustrates an example of the configuration of an edge switch 40 according to the first embodiment.

The edge switch 40 is configured to include a data forwarding circuit 1, an access port(s) 2, a network port(s) 3, a control circuit 4 for the access port(s) 2, a CPU 5, memory 6, and a memory bus 7. A plurality of access ports 2 and network ports 3 can be included. The CPU 5, the memory 6, the control circuit 4, and the data forwarding circuit 1 are connected through the memory bus 7. The memory 6, the control circuit 4, and the data forwarding circuit 1 are assigned to a memory space visible to the CPU 5 so that they can be accessed by software.

The data forwarding circuit 1 is configured by physical layer processing units (referred to as “PHY” in the drawings) for performing processes at the physical layer, for example, performing an OE/EO (optical-to-electrical and electrical-to-optical) conversion, and a switch unit. The data forwarding circuit 1 outputs a frame input from any access port 2 to the network port 3 corresponding to the destination, and outputs a frame input from any network port 3 in the inverse direction to the access port 2 corresponding to the destination.

A communication module 16 for a user network is connected to the access port 2.

The communication module 16 used to connect a user network to a wide area network via an optical cable is removable from the access port 2, and has a memory area such as a register that allows an operator to read and write data in addition to a memory area to which vendor information etc. is usually written. The memory in the communication module 16 stores in advance an identification number corresponding to the access port 2 for which a connection is made. An identification number assigned to each access port 2 is unique in the entire wide area network.

The network port 3 is to connect the edge switch 40 to a transmission medium of the wide area network.

The interrupt output of the control circuit 4 is connected to the interrupt input (referred to as “IF2” in the drawings) of the CPU 5. When the communication module 16 is connected, the control circuit 4 detects the connection, and issues an interrupt notification to the CPU 5. The interrupt informs that the communication module 16 has just be enconnected, and the information to indicate which access port 2 the communication module 16 is connected to is recorded as a factor of the interrupt on the register in the control circuit 4.

Upon receipt of the interrupt notification, the CPU 5 activates a routine to interrupt the software, and reads the interrupt factor (namely, information that indicates at which access port the connection of the communication module has been detected) in the control circuit 4 through the memory bus 7. The reading process cancels the interrupt notification output from the control circuit 4. The identification number in the communication module 16 can be read from the CPU 5 through the control circuit 4 and the access port.

As many areas for recording respective identification numbers are allocated in the memory 6 as the number of access ports, and each identification number corresponding to each access port 2 is set in each area.

FIG. 5B is an explanatory view of the operation sequence of the edge switch according to the first embodiment.

When the communication module 16 is connected to a certain access port 2, the control circuit 4 detects the connection of the communication module 16, and generates an interrupt on the CPU 5.

The software of the CPU 5 that has recognized the connection of the communication module 16 by the interrupt notification from the control circuit 4 reads the identification number recorded in the communication module 16. The software determines whether or not a switchover has occurred on the basis of the comparison between the read identification number and the identification number (stored in the memory 6) assigned to the access port 2 to which the communication module 16 has just been connected.

When it is determined that a switchover has occurred, the identification number recorded in the communication module 16 is replaced with the identification number that is assigned to the access port 2 and that is stored in the memory 6.

FIG. 5C is an explanatory view of the flow of the communication module switching-over process by the software in an edge switch according to the first embodiment. The processing flow corresponds to the operation sequence of the CPU 5 illustrated in FIG. 5B.

The software of the communication module switching-over process is activated upon detection of the connection of the communication module 16 to the access port 2. The detection of the connection is performed by notification by an interrupt from the control circuit 4.

When the connection of the communication module 16 to the access port 2 is detected, an identification number is read from the register in the communication module 16 in step S51. Next, in step S52, an identification number assigned to the access port 2 is read from the memory 6.

In step S53, the identification numbers read in steps S51 and S52 are compared with each other for a matching/non-matching status.

If they match each other, it is determined that the once disconnected communication module has been re-connected, thereby terminating the process. If not, it is determined that the communication module 16 that had been connected to a different access port 2 has just been connected (step S54). The processes in steps S53 and S54 correspond to the determining process of the CPU 5 illustrated in FIG. 5B.

Then, in step S55, the identification number recorded on the register in the communication module 16 is replaced with the identification number of the access port 2 read from the memory 6.

As clarified in the description above, in the first embodiment, the software running on the CPU 5 realizes a switchover determination unit configured to read a first identification number recorded in a storage unit of the connected communication module, to compare the first identification number with the second identification number assigned to the access port to which the communication module is connected, and to determine whether or not a user network has been switched over. The software running on the CPU 5 also realizes an identification number writing unit configured to write to the storage unit of the communication module the second identification number assigned to the access port to which the communication module is connected. The identification number storage unit configured to store the second identification number assigned to the access port is realized by the memory 6.

The above-mentioned functions allow a switchover between access ports (e.g., a switchover between access ports of edge switches paired to form a redundant system) to be automatically recognized by the software operating in an edge switch device.

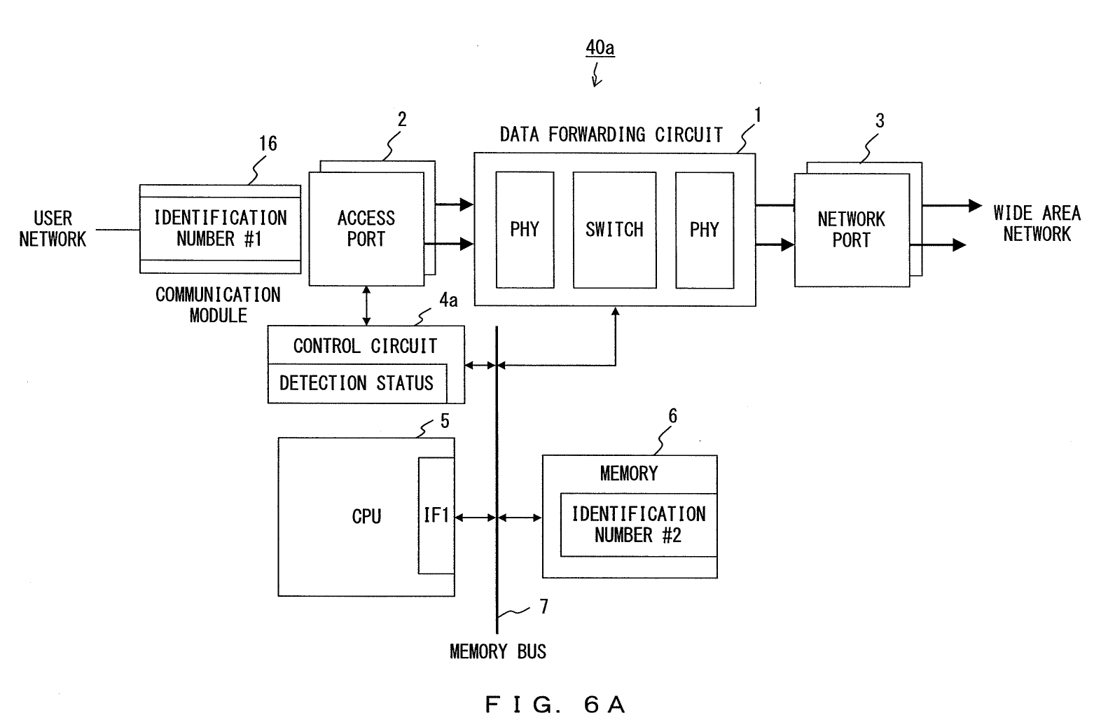

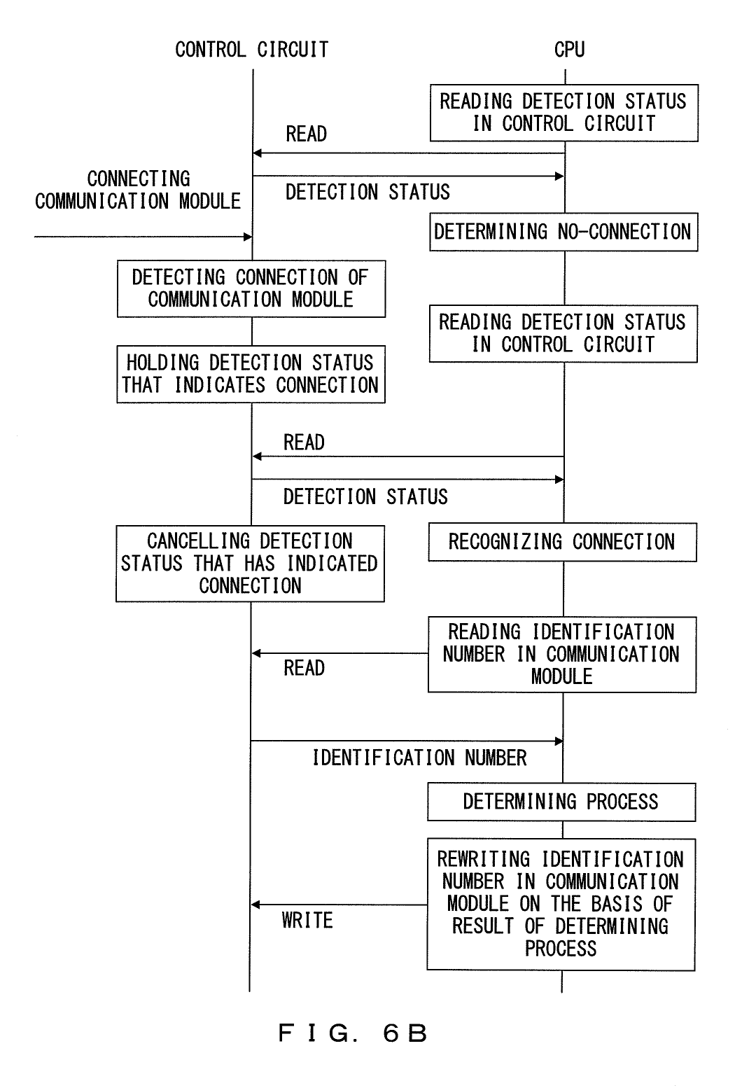

Described next with reference to FIGS. 6A through 6B is the second embodiment. The configuration of the second embodiment is obtained from that of the first embodiment by the following modifications: removing the interrupt control by the control circuit; providing a register in the control circuit to hold the detection status indicating whether or not the communication module 16 has been connected; and the software running on the CPU 5 periodically monitoring (i.e., polling) the register, thereby recognizing the connection of the communication module 16.

FIG. 6A illustrates an example of the configuration of the edge switch 40a according to the second embodiment. As compared with the configuration example according to the first embodiment illustrated in FIG. 5A, it is different in that a register for holding the detection status that indicates whether or not the communication module 16 has been connected is provided in a control circuit 4a, and it is also different in that there is no interrupt output. Registers, each for holding the detection status, are implemented as many as the number of provided access ports.

When the communication module 16 is connected, the control circuit 4a for the access ports detects the connection, and holds the detection status in the corresponding register.

The software periodically monitors the registers through the memory bus 7, thereby being enabled to recognize that the communication module 16 has been connected. The detection status of the register is cancelled (in other words, reset or turned off) by the reading operation from the software.

FIG. 6B is an explanatory view of the operation sequence of the edge switch according to the second embodiment.

The software of the CPU 5 periodically reads the memory (i.e., the register for holding the detection status) in the control circuit 4a. When the communication module 16 is connected to a certain access port 2, the control circuit 4a detects the connection of the communication module 16, and holds the information that the connection has been detected in the register for holding the detection status. Holding such information may be implemented by, for example, setting a flag.

If, at the time of periodical reading by the CPU 5, the memory in the control circuit 4a holds the detection status indicating that the connection of the communication module 16 has been detected, then the CPU 5 recognizes that the communication module 16 has been connected, and the control circuit 4a resets the register for holding the detection status (e.g., the control circuit 4a resets the flag).

If the software of the CPU 5 has recognized that the communication module 16 has been connected, it subsequently operates in the same way as in the first embodiment illustrated in FIG. 5B. That is, the software of the CPU 5 reads the identification number recorded in the communication module 16, and determines whether or not a switchover has occurred on the basis of the comparison between the thus-read identification number and the identification number assigned to the access port 2 to which the communication module 16 has been connected (note that the latter identification number is stored in the memory 6).

If it is determined that a switchover has occurred, then the identification number recorded in the communication module 16 is rewritten to the identification number that has been assigned to the access port 2 and that is stored in the memory 6.

The flow of the communication module switching-over process performed by the software in the second embodiment is the same as that in the first embodiment. The only difference lies in whether the activation is triggered by a notification of the connection of the communication module 16 by an interrupt, or the activation is triggered by a result of periodically monitoring the register for holding the detection status in the control circuit 4a.

Therefore, as in the first embodiment, the identification number in the communication module 16 is read, and compared with the identification number assigned to the access port 2 to which the communication module 16 has been connected. If they do not match each other, the software determines on the basis of the comparison result that the communication module 16 that had been connected to a different access port 2 has just been connected. If they match each other, it determines that the once disconnected communication module 16 has just been re-connected.

If the software determines that the communication module 16 that had been connected to a different access port 2 has just been connected, then the identification number recorded in the memory in the communication module 16 is rewritten to the identification number of the access port 2 to which the communication module 16 has just been connected.

As described above, the detection status of the communication module 16 held in the register in the control circuit 4a is cancelled by the reading operation from the software.

By the functions above, a switchover between access ports (e.g., a switchover between access ports of edge switches paired to form a redundant system) can be automatically recognized by the software operating in the edge switch without an interrupt.

The configuration of the second embodiment is applicable to even a case where the configuration of the first embodiment is not feasible due to a certain reason such as the necessity to assign the interrupt input of the CPU 5 to another use. Unlike the polling between the switches in the wide area network, the detection of the connection of the communication module 16 embodied by polling the control circuit 4a from the CPU 5 does not impose the load on the entire wide area network, and therefore, the second embodiment can be easily embodied.

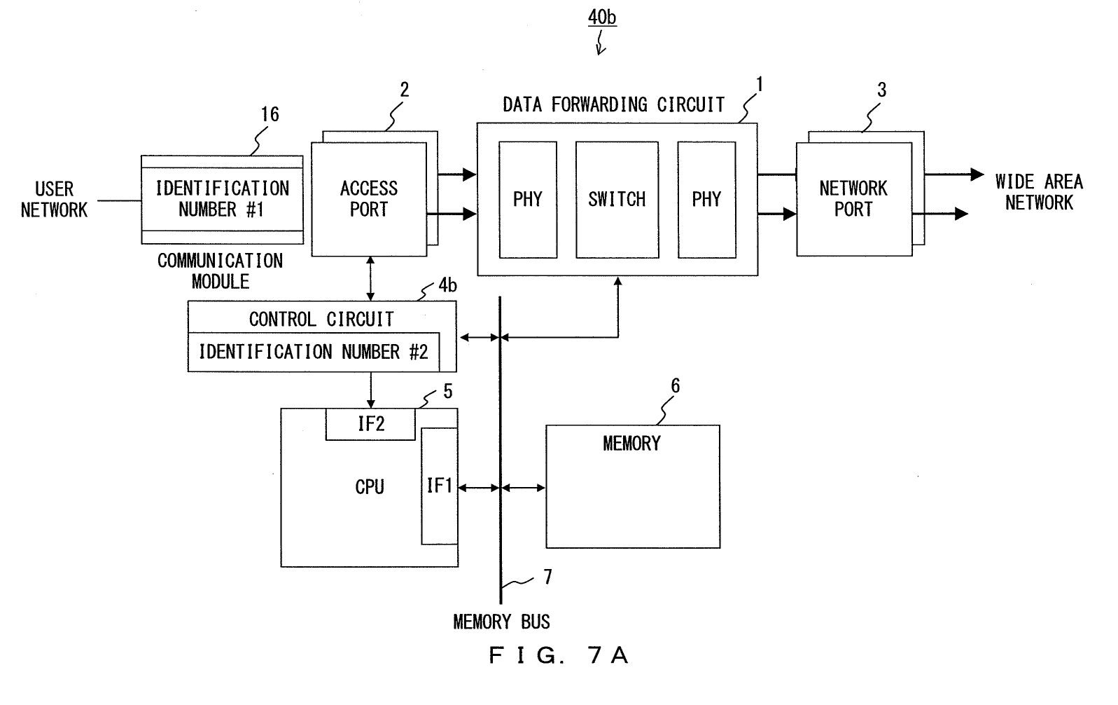

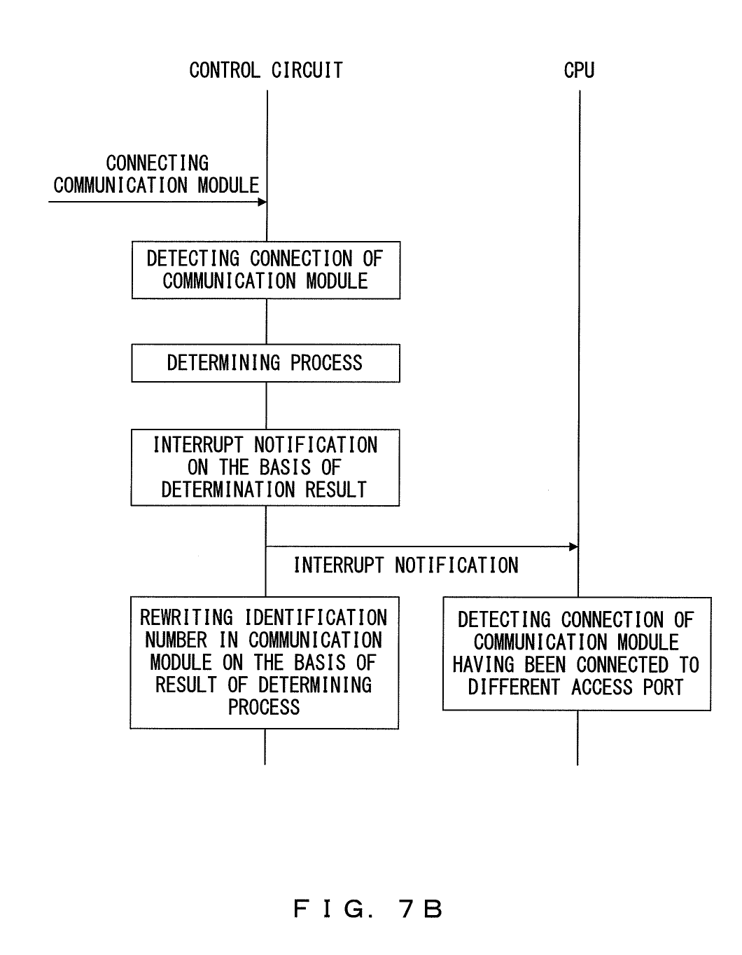

Described next with reference to FIGS. 7A through 7B is the third embodiment. In the third embodiment, the identification number of the access port 2 stored in the memory 6 in the first embodiment is held in a control circuit 4b, and the condition of the interrupt notification on the CPU 5 is modified as follows. That is, in the third embodiment, if the identification number in the communication module 16 whose connection has been detected does not match the identification number of the access port 2 recorded in the control circuit 4b, then the interrupt notification is issued.

FIG. 7A illustrates an example of the configuration of the edge switch 40b according to the third embodiment. As compared with the configuration example according to the first embodiment illustrated in FIG. 5A, it is different in that the control circuit 4b stores the identification number of the access port 2.

FIG. 7B is an explanatory view of the operation sequence of the edge switch according to the third embodiment.

When the communication module 16 is connected to the access port 2, the control circuit 4b detects the connection, reads the identification number in the communication module 16, compares the read identification number with the identification number of the access port 2 stored in the control circuit 4b, and issues an interrupt notification to the CPU 5 if the identification numbers do not match each other.

When a notification from the control circuit 4b is received, the software of the CPU 5 determines that the communication module 16 that had been connected to a different access port 2 has just been connected.

If the control circuit 4b detects that the identification numbers do not match each other, it rewrites the identification number recorded in the memory in the communication module 16 to the identification number of the access port 2 to which the communication module 16 has just been connected.

With the above-mentioned configuration, as compared with the first embodiment, some processes performed by the software when the interrupt notification is received can be removed. That is, the process of reading the identification number in the communication module, the determining process, and the identification number rewriting process can be removed from processes to be performed by the software. Therefore, the time required to activate the subsequent process after performing the process of detecting a switchover of the communication module can be shortened (in other words, the interrupt response can be faster).

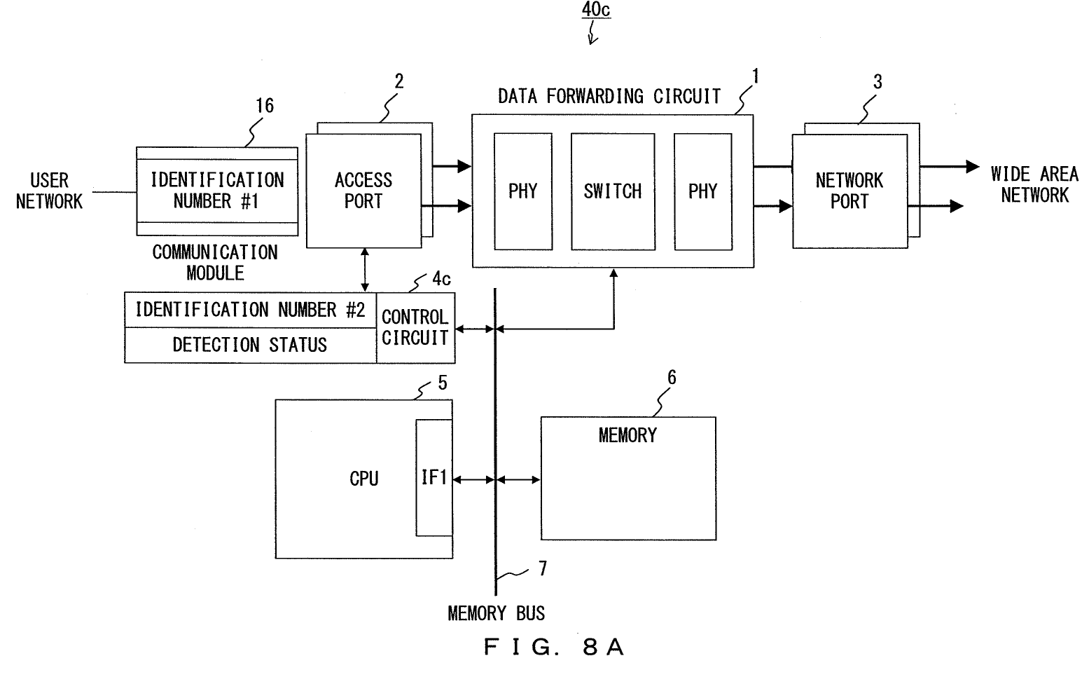

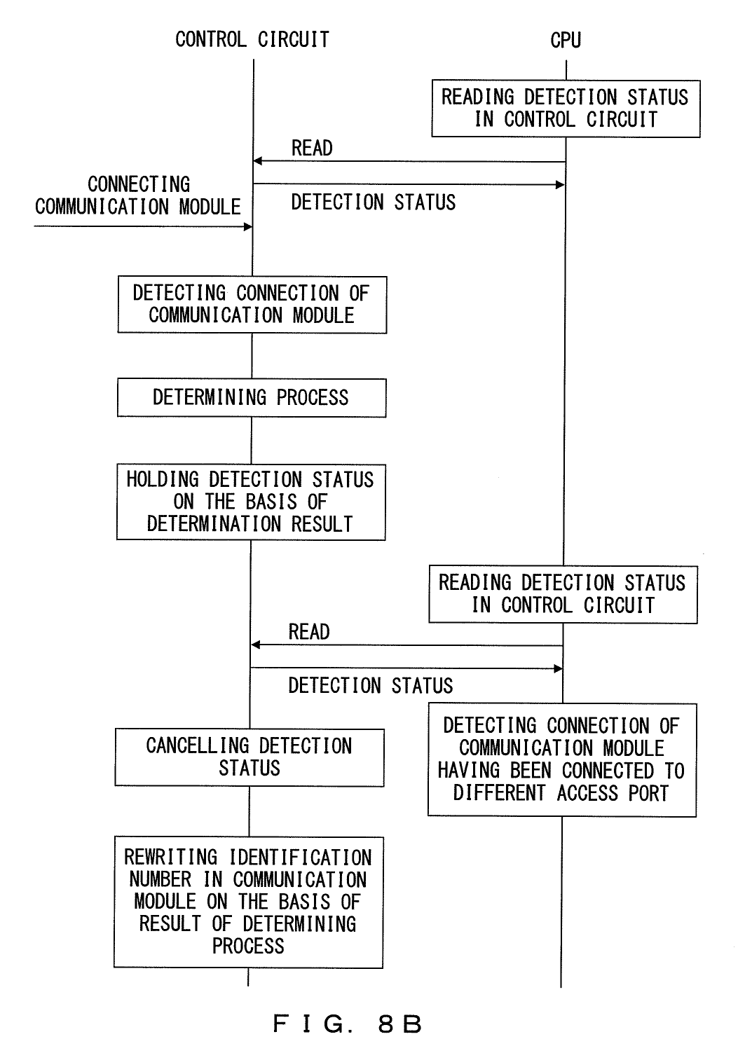

Described next with reference to FIGS. 8A through 8B is the fourth embodiment. In the fourth embodiment, the identification number of the access port 2 stored-in the memory 6 in the second embodiment is held in a control circuit 4c, and the condition to set the detection status is modified as follows. That is, if the identification number in the communication module 16 whose connection has been detected does not match the identification number recorded in the control circuit 4c, then the detection status is set.

FIG. 8A illustrates an example of the configuration of an edge switch 40c according to the fourth embodiment. As compared with the configuration example according to the second embodiment illustrated in FIG. 6A, it is different in that the control circuit 4c stores the identification number of the access port 2.

FIG. 8B is an explanatory view of the operation sequence of the edge switch according to the fourth embodiment.

The software running on the CPU 5 periodically reads the data in the memory (i.e., the register for holding the detection status) in the control circuit 4c. When the communication module 16 is connected to a certain access port 2, the control circuit 4c detects the connection of the communication module 16, and performs the process of determining whether a switchover of the communication module 16 has occurred.

The control circuit 4c is provided with memory storing the identification number of the access port 2, and compares the identification number in the communication module 16 with the identification number in the control circuit 4c in the above-mentioned determining process when the connection of the communication module 16 is detected.

When the comparison result indicates that the identification numbers do not match each other, the detection status indicating that the connection has been detected is held in the register for holding the detection status.

The software running on the CPU 5 periodically monitors the memory in the control circuit 4c, and determines that the communication module 16 that had been connected to a different access port 2 has just been connected when the thus-set detection status is read. The detection status is cancelled (i.e., reset) by the reading operation from the CPU 5.

When the control circuit 4c detects that the identification numbers do not match each other, it rewrites the identification number recorded in the communication module 16 to the identification number of the access port 2 to which the communication module 16 has just been connected.

The configuration according to the fourth embodiment is applicable to even a case where the configuration of the third embodiment is not feasible due to a certain reason such as the necessity to assign the interrupt input of the CPU 5 to another use.

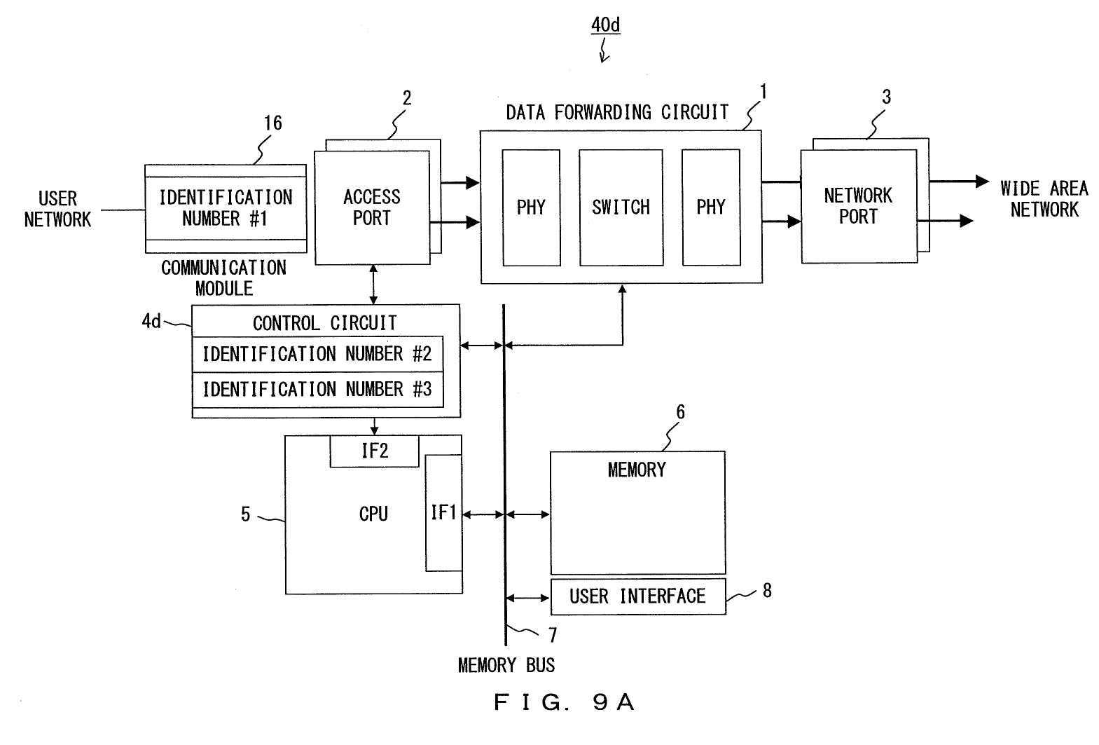

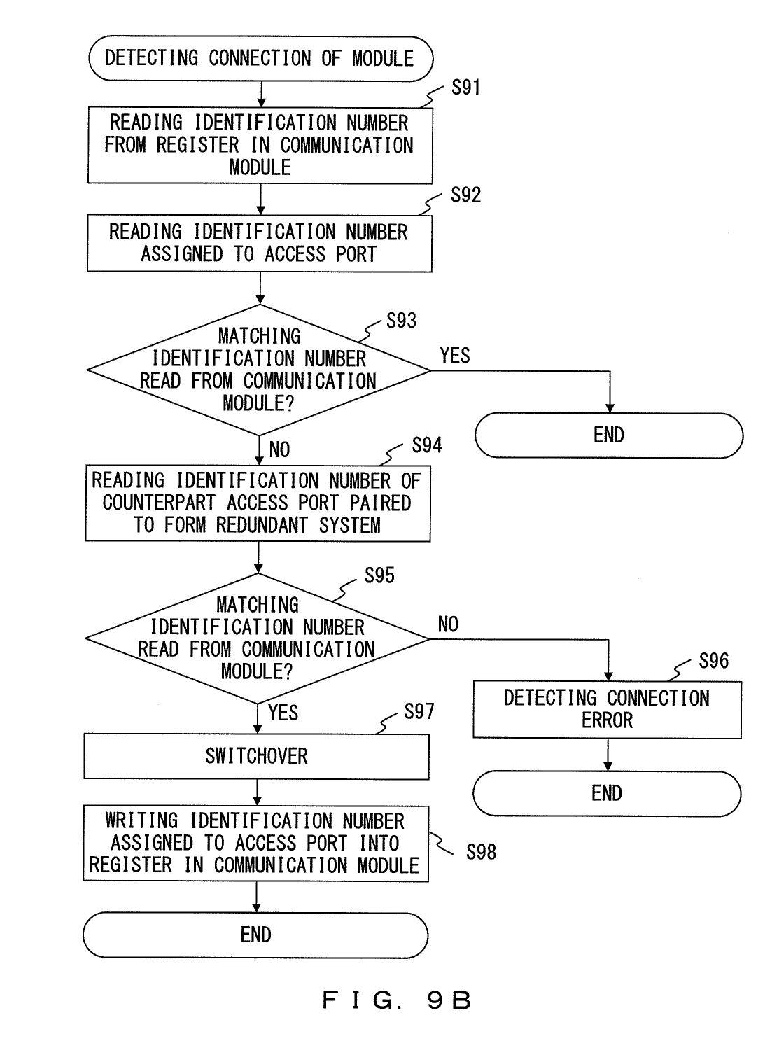

Described next with reference to FIGS. 9A through 9B is the fifth embodiment. In the fifth embodiment, the control circuit 4b for the access port in the third embodiment is replaced with a control circuit 4d. A memory area is provided in the control circuit 4d for storing, in addition to the identification number of the access port 2, an identification number of a counterpart access port paired with the access port 2 to form a redundant system. In determining, by the control circuit 4d, whether or not a switchover of the communication module 16 has occurred, a switchover between the access ports paired to configure the redundant system is determined to be a normal switchover, and it is determined that other switchovers are connection errors.

It is also provided with a user interface 8 connected to the memory bus 7. According to the fifth embodiment, when it is determined that a connection error has occurred, the connection error can be informed to the maintainer through the user interface 8.

FIG. 9A illustrates an example of the configuration of the edge switch 40d according to the fifth embodiment. As compared with the example of the configuration according to the third embodiment illustrated in FIG. 7A, it is different in that the identification number (illustrated with the sign “#3”) of the counterpart access port paired with the access port 2 to configure a redundant system is stored in the control circuit 4d in addition to the identification number (illustrated with the sign “#2”) of the access port 2; and it is also different in that the user interface 8 is connected to the memory bus 7. Storage areas for the identification numbers (illustrated with the sign “#3”) of the counterpart access ports, each of which is paired with the access port 2 to configure the redundant system, are allocated as many as the number of the access ports 2.

With respect to the normal switchover, the operation sequence of the control circuit 4d and the CPU 5 is approximately equivalent to that in the third embodiment illustrated in FIG. 7B though somewhat different in the contents of the determining process.

Described below is the process flow including the case in which it is determined as a connection error.

FIG. 9B is an explanatory view of the flow of the communication module switching-over process performed by the control circuit 4d according to the fifth embodiment.

When the control circuit 4d detects the connection of the communication module 16 to the access port 2, it reads an identification number from the register in the communication module 16 in step S91. Then, in step S92, it reads the identification number assigned to the access port 2 from the memory area in the control circuit 4d.

In step S93, the identification numbers read in steps S91 and S92 are compared with each other to check whether or not they match each other.

If they match each other, it is determined that a once disconnected communication module has just been connected again, and the process terminates. If not, control is passed to step S94, and the identification number (illustrated with the sign “#3”) of the counterpart access port that configures a redundant system with the access port 2, to which the communication module 16 has just been connected, is read.

In step S95, the identification numbers read in steps S91 and S94 are compared with each other to check whether or not they match each other.

If it is determined that they do not match each other as a result of the comparison in step S95, then control is passed to step S96, the detection of the connection error is notified to the CPU 5 by an interrupt, and then, the process terminates.

If it is determined that the identification numbers read in steps S91 and S94 match each other as a result of the comparison in step S95, namely, if the communication module 16 that has just been connected had been connected to the counterpart access port paired to configure a redundant system, then in step S97, the CPU 5 is notified by an interrupt that a normal switchover has occurred.

Finally in step S98, the identification number recorded in the memory in the communication module 16 is rewritten to the identification number of the access port 2 to which the communication module 16 is connected, and then, the process terminates.

If there is an interrupt triggered by a normal switchover, the software running on the CPU 5 determines that the communication module that had been connected to the counterpart access port paired to form a redundant system has just been connected.

If there is an interrupt triggered by a connection error, the software determines that a connection error has occurred in connecting the communication module. In this case, an error message indicating a connection error can be displayed for the maintainer through the user interface 8.

The above-described configuration enables the software to implement the process to be performed when a connection error is caused by a maintainer in switching-over between the access ports configuring a redundant system. An example of such a process is the process of outputting a message to notify the maintainer that the connection error has occurred and to prompt the maintainer to take countermeasures against the connection error.

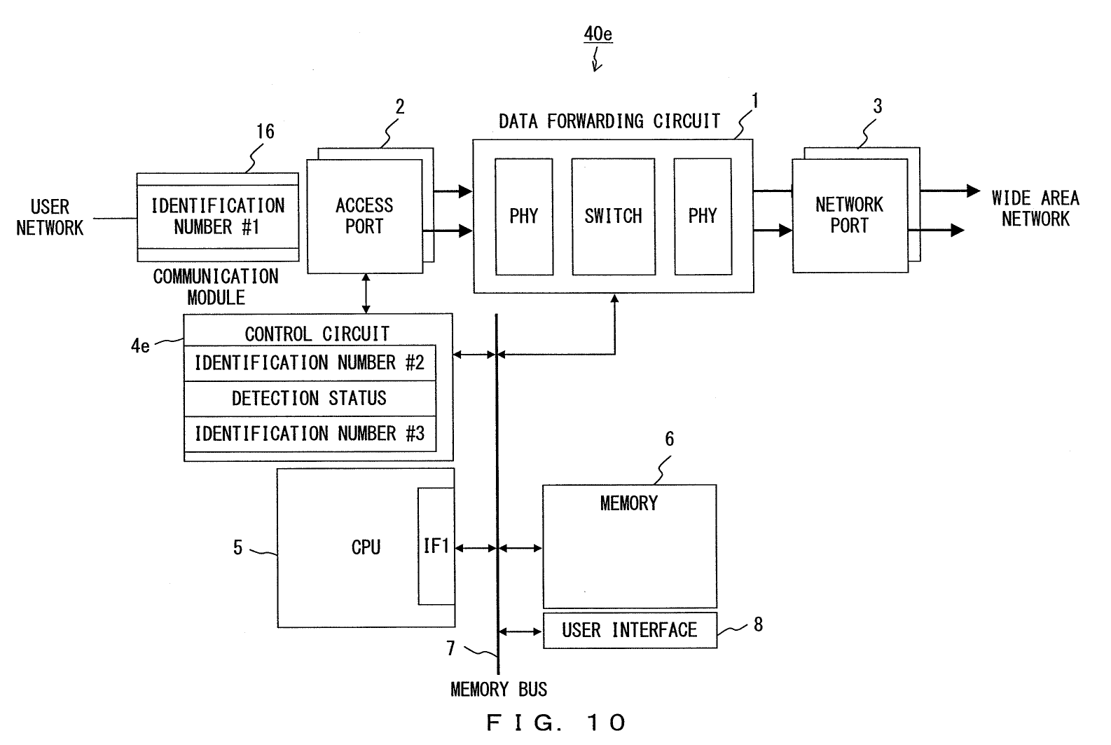

Described next with reference to FIG. 10 is the sixth embodiment. In the sixth embodiment, the control circuit 4c for the access port according to the fourth embodiment illustrated in FIG. 8A is replaced with a control circuit 4e. The control circuit 4e is further provided with a memory area for storing the identification number (illustrated with the sign “#3”) of the counterpart access port paired to configure a redundant system. As in the fifth embodiment, when the control circuit 4e determines whether or not a switchover of the communication module 16 has occurred, the switchover between the access ports configuring a redundant system is determined to be a normal switchover, and other switchovers are determined to be connection errors.

As in the fifth embodiment, the user interface 8 connected to the memory bus 7 is further included. According to the sixth embodiment, when it is determined that a connection error has occurred, the connection error can be notified to the maintainer through the user interface 8. Thus, the countermeasures can be taken in the sixth embodiment, as well as in the fifth embodiment, when the connection error has caused by the maintainer in switching-over between the access ports configuring a redundant system.

FIG. 10 illustrates an example of the configuration of the edge switch 40e according to the sixth embodiment. As compared with the example of the configuration according to the fourth embodiment illustrated in FIG. 8A, it is different in that the control circuit 4e stores the identification number (illustrated with the sign “#3”) of the counterpart access port paired with the access port 2 to configure a redundant system, in addition to including a register for holding the detection status of the communication module and storing the identification number (illustrated with the sign “#2”) of the access port 2; and it is also different in that the user interface 8 is connected to the memory bus 7. Storage areas for the identification numbers (illustrated with the sign “#3”) of the counterpart access ports, each of which is paired with the access port 2 to configure the redundant system, are allocated as many as the number of the access ports 2.

When the connection of the communication module 16 is detected, the control circuit 4e compares the identification number (illustrated with the sign “#1”) in the communication module 16 with the identification number (illustrated with the sign “#2”) in the control circuit 4e. If they do not match each other and the latter matches the identification number (illustrated with the sign “#3”) of the counterpart access port paired to configure the redundant system, the detection status is set and held.

The software running on the CPU 5 periodically reads data from the memory in the control circuit 4e, and when it reads the thus-set detection status, it determines that the communication module having been connected to the counterpart access port paired to form a redundant system has just been connected. The detection status is cancelled (i.e., reset) by the reading operation performed by the CPU 5.

The control circuit 4e compares the identification number (illustrated with the sign “#1”) in the communication module 16 with the identification number (illustrated with the sign “#2”) in the control circuit 4e. If they do not match each other and the former does not match the identification number (illustrated with the sign “#3”) of the counterpart access port paired to form the redundant system, then the status is set and held as the second detection status in a second detection status holding unit (not illustrated in FIG. 10) provided in the control circuit 4e.

The software running on the CPU 5 periodically reads data from the memory in the control circuit 4e, and determines that a connection error has occurred in connecting the communication module if the thus-set second detection status is read. In this case, as in the fifth embodiment, an error message indicating a connection error can be displayed for the maintainer through the user interface 8.

When the control circuit 4e determines that the communication module 16 that had been connected to the counterpart access port paired to form a redundant system has just been connected, it rewrites the identification number recorded in the memory in the communication module 16 to the identification number of the access port 2 to which the communication module 16 is connected.

This configuration can be used when the configuration according to the fifth embodiment is not feasible due to a certain reason such as the necessity to assign the interrupt input of the CPU 5 to another use.

Described above is the first aspect relating to the detection of the switchover of a communication module detected by an edge switch according to the first through sixth embodiments.

Described below with reference to the seventh through ninth embodiments is the second aspect in which an edge switch that has detected a switchover of a communication module notifies another switch of the switchover.

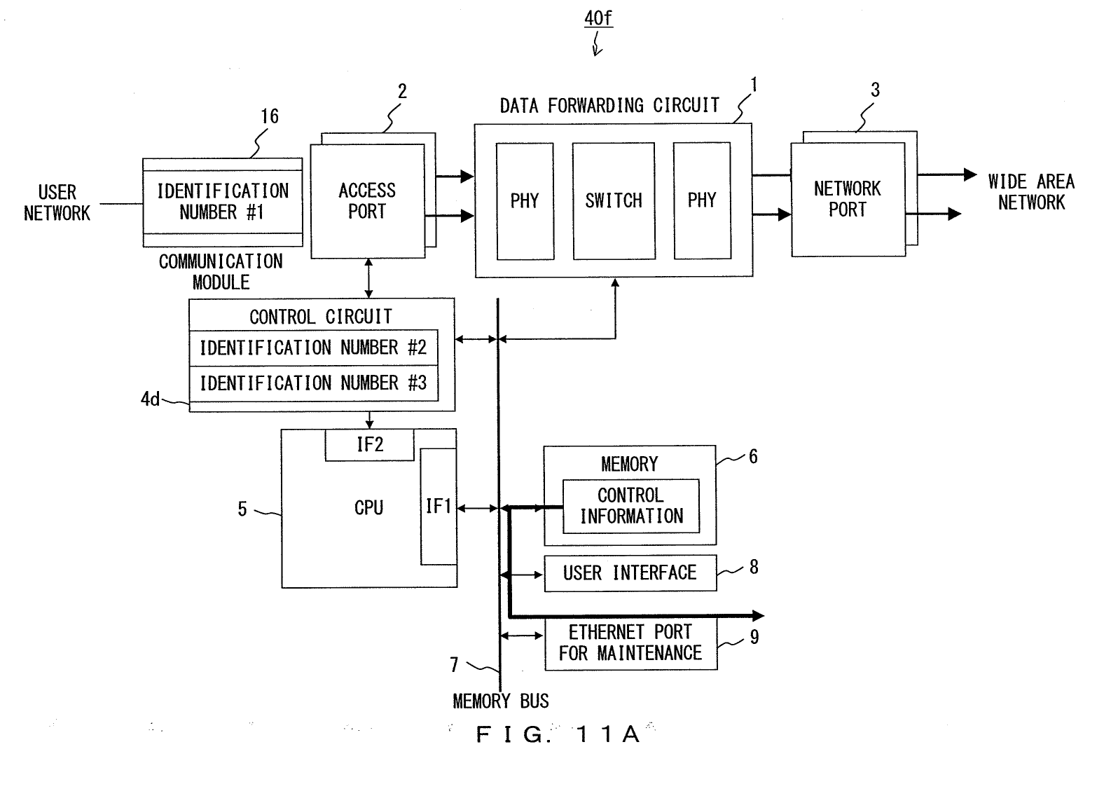

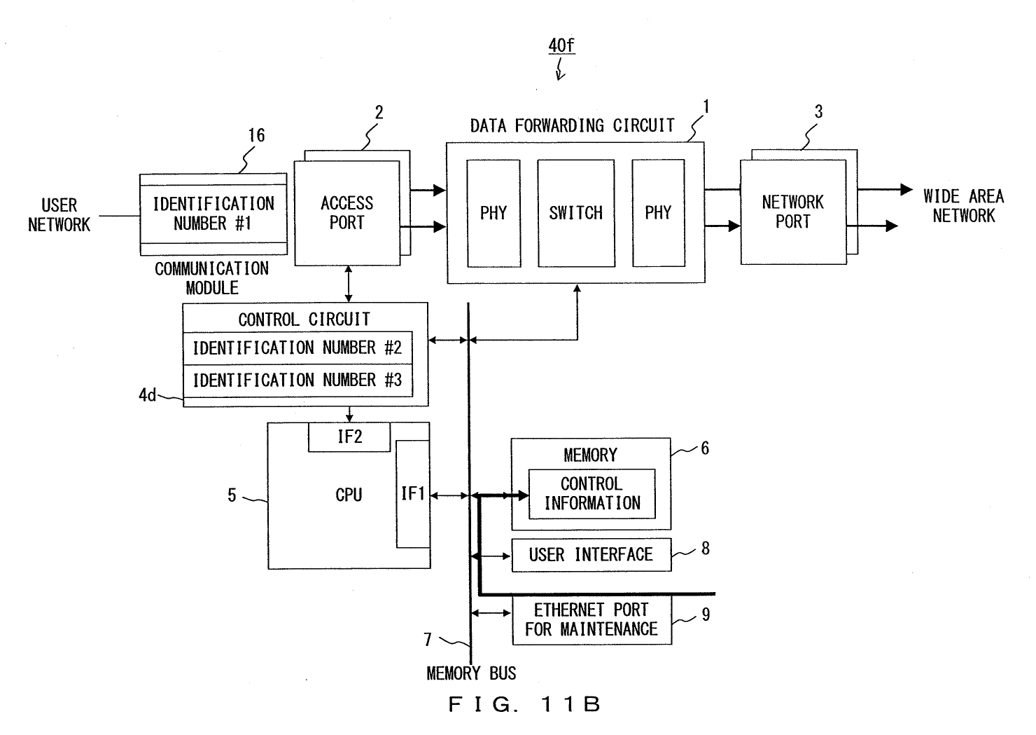

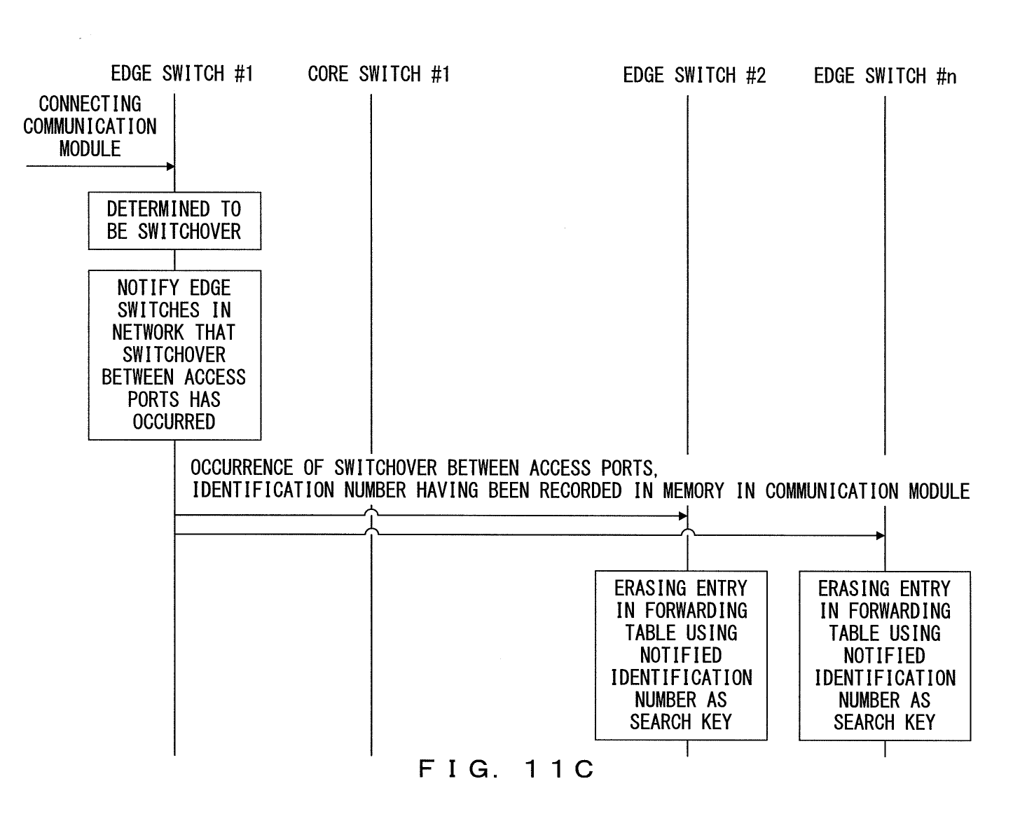

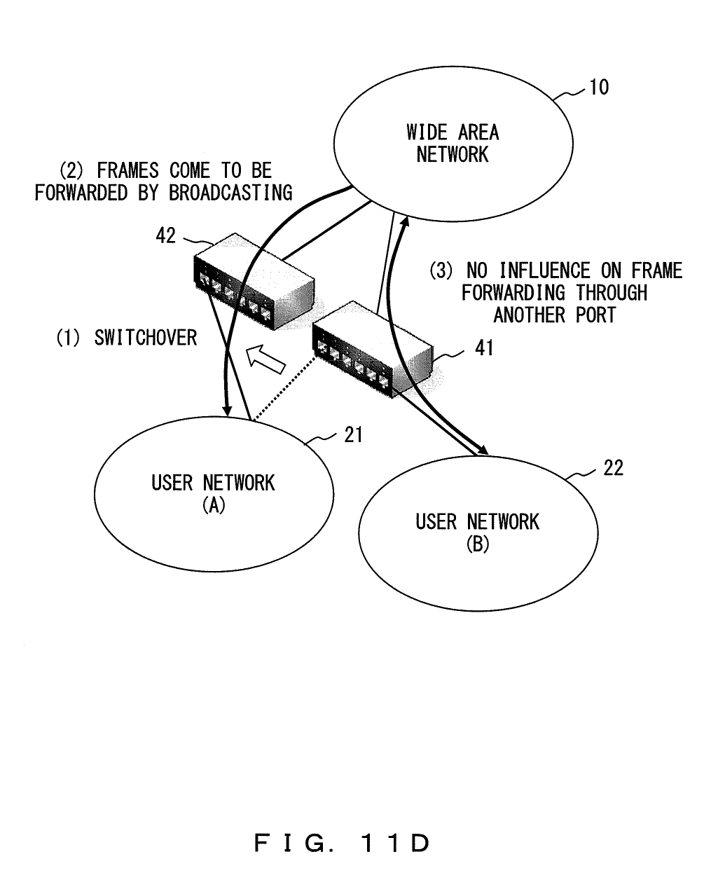

The seventh embodiment is first described below with reference to FIGS. 11A through 11D. In the seventh embodiment, an edge switch that has detected a switchover of a user network (that is, a switchover of a communication module for connecting the user network to the edge switch) notifies, over a control network for a wide area network, other switches of the identification number of an access port to which the communication module had been connected before the switchover. Upon receipt of the notification, each of the other switches deletes an entry including the notified identification number from its forwarding table.

FIG. 11A is an explanatory view of the operation of the transmitting edge switch according to the seventh embodiment. As an example of a control circuit of an edge switch 40f, the control circuit 4d according to the fifth embodiment illustrated in FIG. 9A is illustrated in FIG. 11A, but any control circuit in the first through sixth embodiments can be applied.

As illustrated in FIG. 11A, an Ethernet port 9 for maintenance is provided for the edge switch 40f, is connected to the memory bus 7, and is connected to a control network. The communication function according to a certain protocol such as a TCP/IP (transmission control protocol/internet protocol) is incorporated into control software operating in each edge switch. Note that the TCP/IP is implemented in most operating systems.

The contents of a message transmitted between the software components each of which operates on the CPU 5 of the edge switch 40f include the following information. That is, the IP address assigned to each edge switch and the port number assigned to an application are included in the message to indicate a destination; and the communication contents of the message include a command to be provided for the application and an argument to be used at the runtime of the command.

The command used in the seventh embodiment is “erase an entry in the forwarding table”, and the argument to be used at the runtime of the command is the identification number of the access port recorded in the memory in the communication module.

An EoE MAC address is recorded in the memory in the communication module 16 as an identification number identifying the access port 2 of the edge switch 40f. The EoE MAC address is assigned a value that is unique for each access port and that is unique in the entire wide area network.

When the software running on the CPU 5 detects a switchover of a communication module configured to be connected to the access port 2, it generates control information on the memory 6 as a message notifying that the switchover between access ports has occurred. And then, the software notifies edge switches in the wide area network of the control information over a control network connected to the edge switch 40f. The notification contents include the identification number having been recorded in the memory in the communication module.

The notification of the switchover of the communication module 16 is issued by the software that has detected the connection of the communication module in the following manner if the control circuit 4 or 4a of the first or second embodiment is applied. That is, the software reads the identification information in the communication module 16, and determines that the communication module 16 that had been connected to a different access port 2 has just been connected, thereby the notification being issued.

When the control circuit 4b or 4c according to the third or fourth embodiment is applied, the control circuit 4b or 4c detects the connection of the communication module 16 that had been connected to a different access port 2. The software issues a notification of a switchover of the communication module 16 on the basis of the detection result of the control circuit 4b or 4c.

When the control circuit 4d or 4e according to the fifth or sixth embodiments is applied, a notification of the switchover of the communication module 16 is issued only when a connection of the communication module 16 that had been connected to a counterpart access port paired to form a redundant system is detected.

FIG. 11B is an explanatory view of the operation of the receiving edge switch 40f according to the seventh embodiment.

The control information notified by the transmitting edge switch 40f is stored in the memory 6 through the control network, the Ethernet port 9 for maintenance, and the memory bus 7.

Upon receipt of the notification, the software of the receiving edge switch 40f erases the entry of the forwarding table in the edge switch 40f itself using the identification number as a search key.

FIG. 11C is an explanatory view of the operation sequence between the switches.

FIG. 11C illustrates the following operation sequence. The communication module is connected. And then, the edge switch #1 determines that the connection is a switchover between the access port and the communication module. The switch #1 then notifies other edge switches #2 through #n in the wide area network of the fact that the switchover has occurred and of the EoE MAC address having been recorded in the memory in the communication module. Upon receipt of the notification, each of the edge switches #2 through #n erases its entry in the forwarding table in the edge switch itself using the notified identification number (i.e., EoE MAC address) as a search key.

FIG. 11D is an explanatory view of the influence on other access ports when a switchover occurs.

(1) Assume that a user network (A) 21 that has been connected to an edge switch 41 is switched over to an edge switch 42.

(2) When other edge switches erase their respective entries upon receipt of a switchover notification, each of them comes to forward a frame addressed to the user network (A) 21, whose communication module had been connected to the access port of the edge switch 41, by broadcasting.

(3) Each of the other edge switches deletes its entry in the forwarding table using, as a search key, the EoE MAC address having been recorded in the memory in the communication module. Accordingly, the deletion does not affect frame forwarding through another access port, for example, an access port of the edge switch 41 to which a user network (B) 22 is connected.

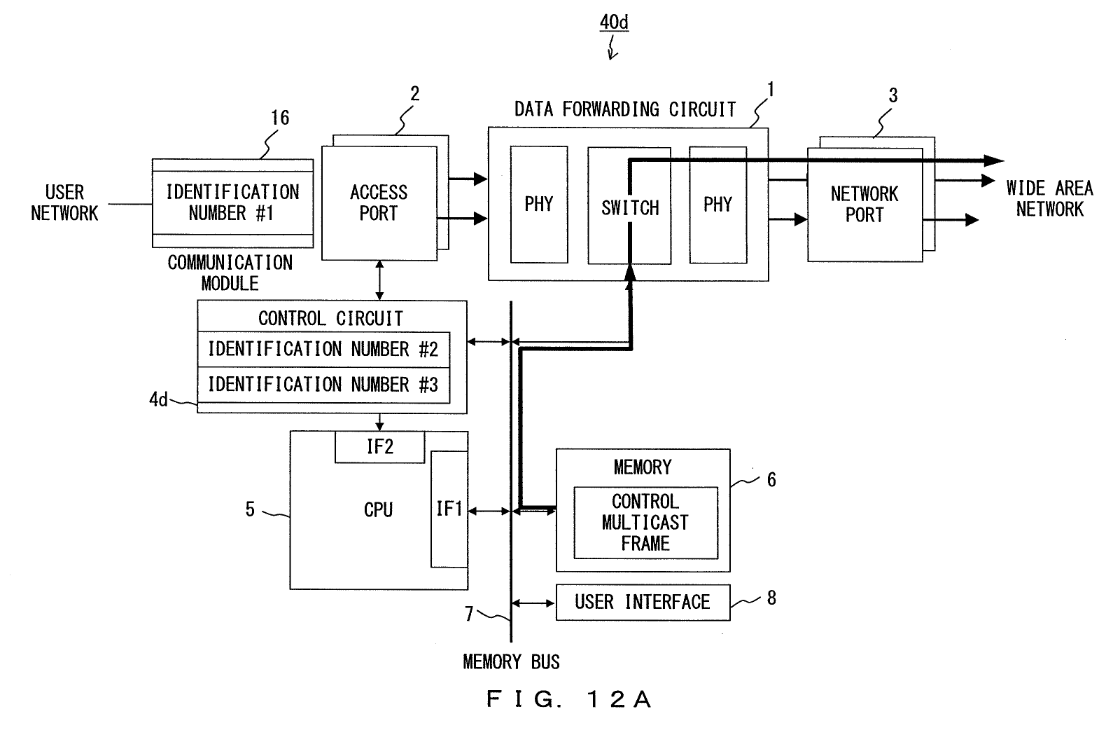

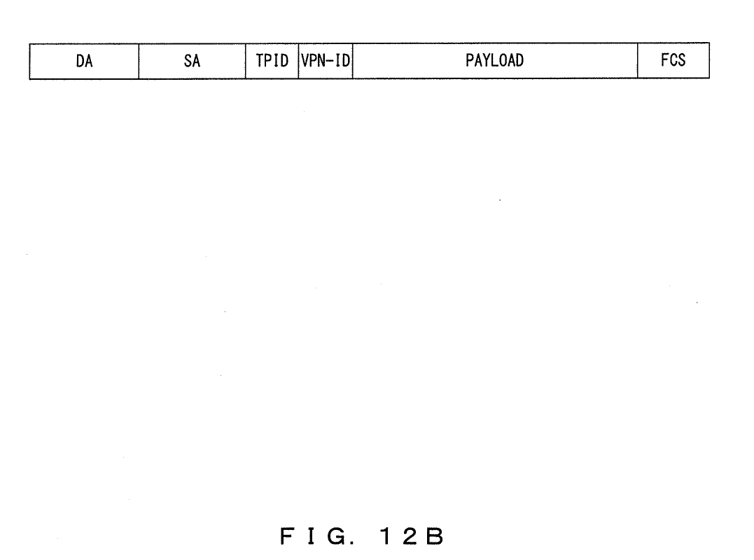

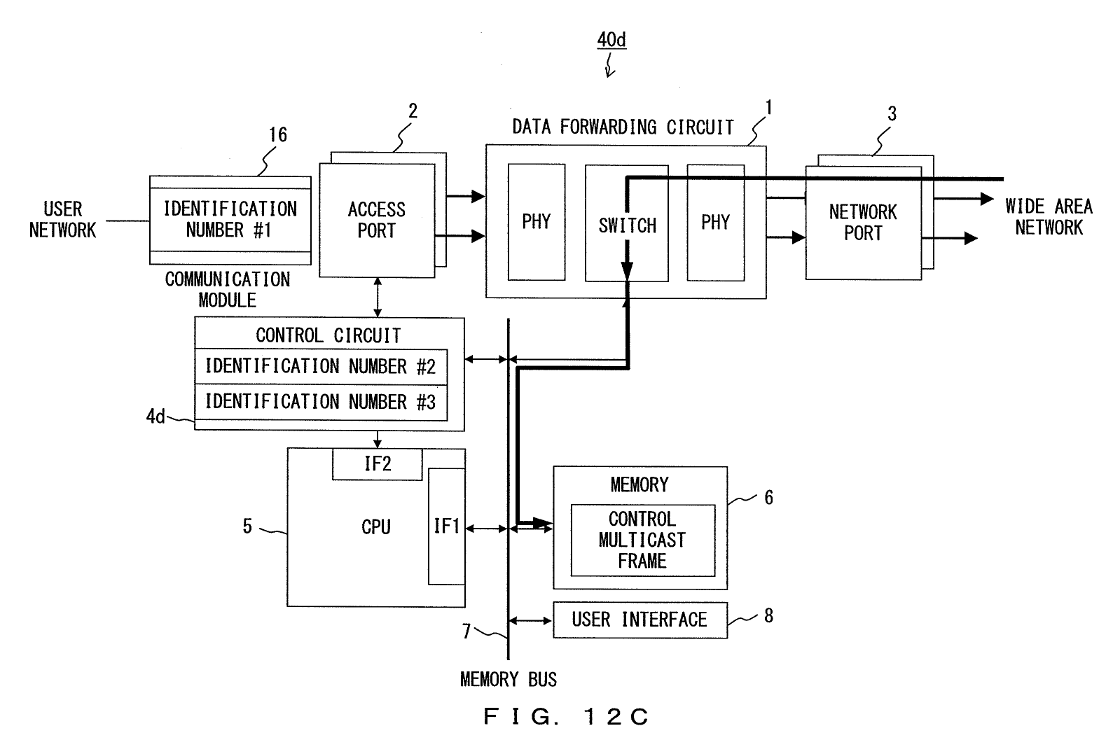

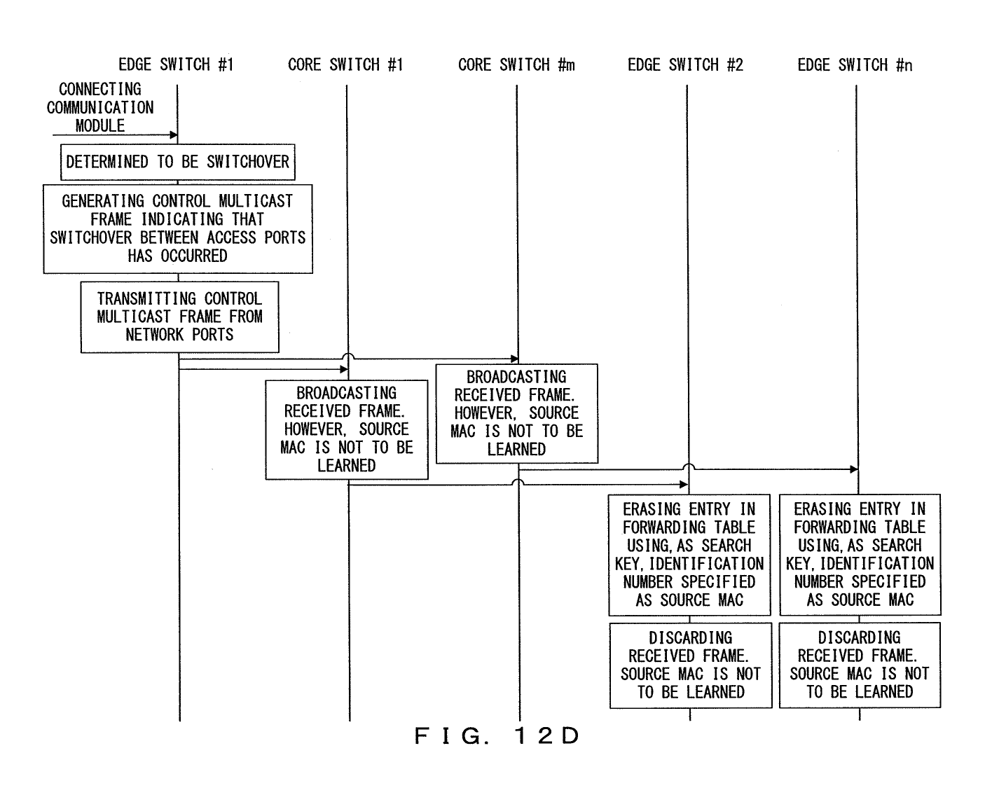

Described next with reference to FIGS. 12A through 12D is the eighth embodiment. In the eighth embodiment, an edge switch that has detected a switchover of a user network (that is, a switchover of a communication module for connecting the user network to the edge switch) notifies, over a wide area network, other switches of the identification number of an access port to which the communication module had been connected before the switchover. Upon receipt of the notification, each of the other switches deletes an entry including the notified identification number from its forwarding table.

FIG. 12A is an explanatory view of the operation of the transmitting edge switch according to the eighth embodiment. As an example of an edge switch, the edge switch 40d according to the fifth embodiment is illustrated in FIG. 12A, but the configuration of the edge switch is not limited to that in the fifth embodiment. That is, as in the case of the seventh embodiment, any edge switch in the first through sixth embodiments can be applied.

When the edge switch 40d determines that the communication module 16 that had been connected to the counterpart access port 2 paired to form a redundant system has just been connected, it generates a frame to notify the status change by software.

When the frame is generated by the software, it is stored in the memory 6, then transmitted to the data forwarding circuit 1 through the memory bus 7, and further transmitted to the network ports 3 as a control multicast frame. The control multicast frame is transmitted from all network ports 3 accommodated in the edge switch 40d.

When either of the edge switches 40 through 40c according to the first through fourth embodiments is used, a frame to notify the status change is generated by software upon detection of the connection of the communication module 16 that had been connected to a different access port 2, and the frame is transmitted as a control multicast frame to the network ports 3.

FIG. 12B is an explanatory view of the configuration of the control multicast frame according to the eighth embodiment.

A control multicast address indicating that this frame is a control multicast frame is set in the destination address (DA) field illustrated in FIG. 12B; and the identification number (i.e., EoE MAC address) of the access port 2 having been recorded in the memory in the communication module 16 is set in the source address (SA) (i.e., source MAC address) field.

A frame type identifying a protocol used by this frame is set in the frame type field (i.e., TPID field; tag protocol identifier field); and a VPN-ID value is set in the VPN-ID field as an identifier of a virtual private network.

A payload is used for frame length adjustment and any contents can be stored in the payload.

A frame check sequence (FCS) is finally appended.

FIG. 12C is an explanatory view of the operation of the receiving edge switch according to the eighth embodiment.

A frame having a control multicast address among the frames received by the network port 3 is forwarded, on the basis of the determination by the data forwarding circuit 1, to the CPU 5 by way of the memory 6 to be processed by software.

When the CPU 5 receives a control multicast frame, it erases an entry in the forwarding table in the edge switch 40d using the source MAC address in the control multicast frame as a search key. The source MAC address of the control multicast frame is not to be learned.

In the eighth embodiment, since information to notify a switchover is transmitted through a wide area network as a control multicast frame, the control multicast frame is also received by a core switch. The core switch forwards the control multicast frame to a switch (or switches) at the subsequent stage as with a normal broadcast frame. However, in this case, the source MAC address of the control multicast frame is also not to be learned.

FIG. 12D is an explanatory view of the operation sequence between the switches according to the eighth embodiment.

When a communication module is connected and an edge switch #1 determines that the connection is a switchover between an access port and the communication module, the edge switch #1 generates a control multicast frame. A control multicast address indicating that a switchover has occurred between the access port and the communication module is set as a destination address of the control multicast frame; and the identification number having been recorded in the memory in the communication module is set as a source MAC address of the control multicast frame.

Next, the edge switch #1 transmits the control multicast frame from all network ports to a wide area network.

The core switches #1 through #m broadcast the received control multicast frame to a switch (or switches) at the subsequent stage, but the source MAC address is not to be learned.

Each of the edge switches #2 through #n erases its entry in the forwarding table in the edge switch itself using, as a search key, the identification number (i.e., EoE MAC address) set as the source MAC address of the received control multicast frame.

Next, the received control multicast frame is discarded, and the source MAC address is not learned.

After the edge switches #2 through #n that have received a notification of the switchover between the access port and the communication module erase, from their respective forwarding tables, their respective entries having the identification number of the access port from which the communication module has been disconnected, the frame forwarding from the edge switches #2 through #n to a user network whose communication module had been connected to the port of the edge switch #1 is performed by broadcasting, and re-learning is performed.

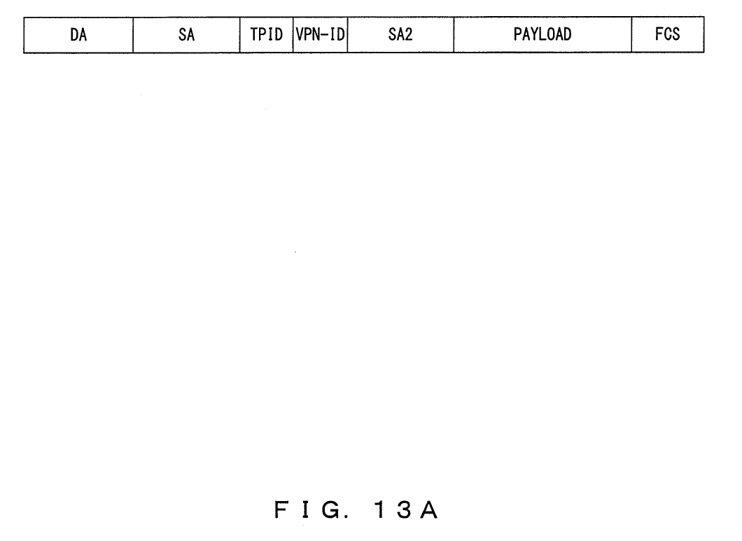

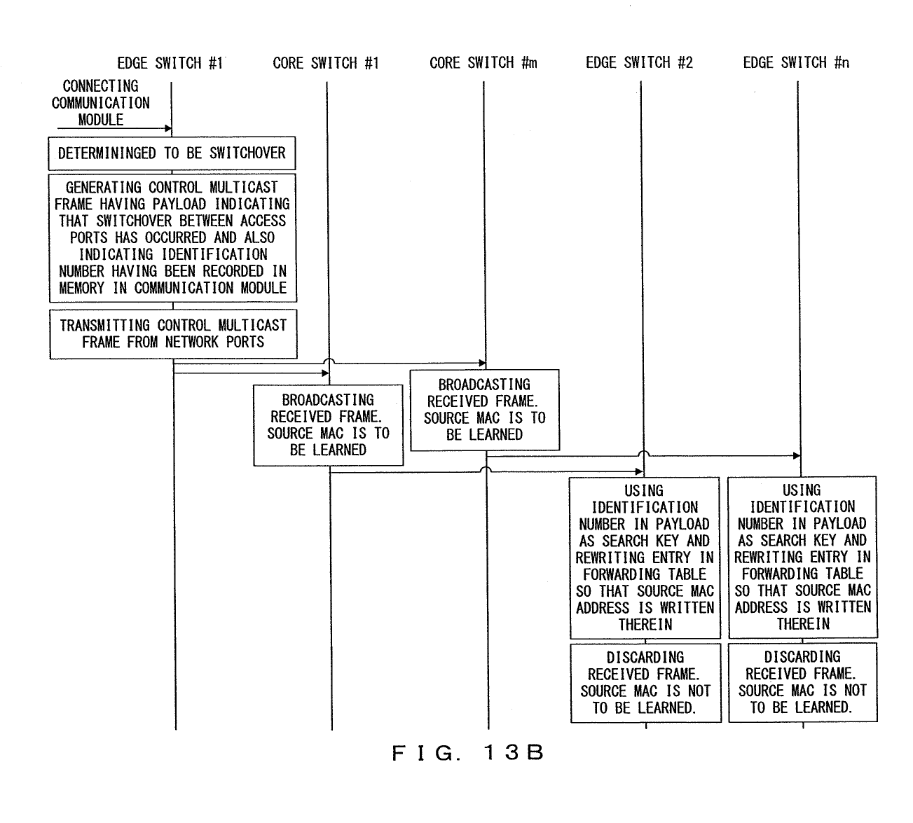

Described next with reference to FIGS. 13A through 13B is the ninth embodiment. In the ninth embodiment, the frame configuration of the control multicast frame according to the eighth embodiment is changed, and the identification number of an access port to which a communication module has just been connected is added.

FIG. 13A is an explanatory view of the configuration of the control multicast frame according to the ninth embodiment. As compared with the configuration of the control multicast frame illustrated in FIG. 12B, it differs in that: the identification number (i.e., EoE MAC address) of the access port 2 to which the communication module 16 has just been connected is set in the source address (SA) field (i.e., source MAC address field); and the identification number (i.e., EoE MAC address) of the access port 2 having been recorded in the memory in the communication module 16 is set in the portion illustrated with the sign “SA2” in the payload.

The configuration of an edge switch is the same as that in the eighth embodiment. The operations of transmitting and receiving edge switches and the operation of a core switch are described below.

FIG. 13B is an explanatory view of the operation sequence between the switches according to the ninth embodiment.

When a communication module is connected and an edge switch #1 determines that the connection is a switchover between an access port and the communication module, the edge switch #1 generates a control multicast frame. A control multicast address indicating that a switchover has occurred between the access port and the communication module is set as a destination address of the control multicast frame; the identification number (i.e., EoE MAC address) of the access port 2 to which the communication module 16 has just been connected is set as a source MAC address of the control multicast frame; and the identification number having been recorded in the memory in the communication module is stored in the payload of the control multicast frame.

Next, the edge switch #1 transmits the control multicast frame from all network ports to a wide area network.

When the core switches #1 through #m receive the control multicast frame, they forward the control multicast frame to a switch (or switches) at the subsequent stage as with the broadcast frame. The source MAC address of the control multicast frame is to be learned as with a normal frame.

When the control multicast frame is received by the edge switches #2 through #n, it is forwarded to the CPU 5 for software processing.

When the CPU 5 receives the control multicast frame, it retrieves the identification number that is stored in the payload and that had been recorded in the memory in the communication module, and the identification number, set as the source MAC address, of the access port to which the communication module has just been connected. The CPU 5 accesses the forwarding table in the edge switch using, as a search key, the identification number stored in the payload. And then, the CPU 5 rewrites, in the found entry, the identification number that is stored in the payload and that had been recorded in the memory in the communication module to the identification number, set as the source MAC address, of the access port to which the communication module has just been connected.

Next, the received control multicast frame is discarded, and the source MAC address is not learned.

As described above, the edge switches rewrite their respective entries in their respective forwarding tables upon receipt of a notification of a switchover between an access port and a communication module, and the core switches on the route learn the source MAC address of the control multicast frame. In other words, each edge switch comes to know which access port of its own a transmission frame is to be transmitted to, and each core switch comes to know which switch at the next stage a received frame is to be forwarded to. Therefore, a frame can be forwarded without broadcasting even after a switchover between an access port and a communication module.

Since a core switches in a network can treat a control multicast frame as a normal broadcast frame, it is not necessary to implement a specific control function of leaving a source MAC address not learned as in the eighth embodiment.

Described next are practical examples according to an embodiment.

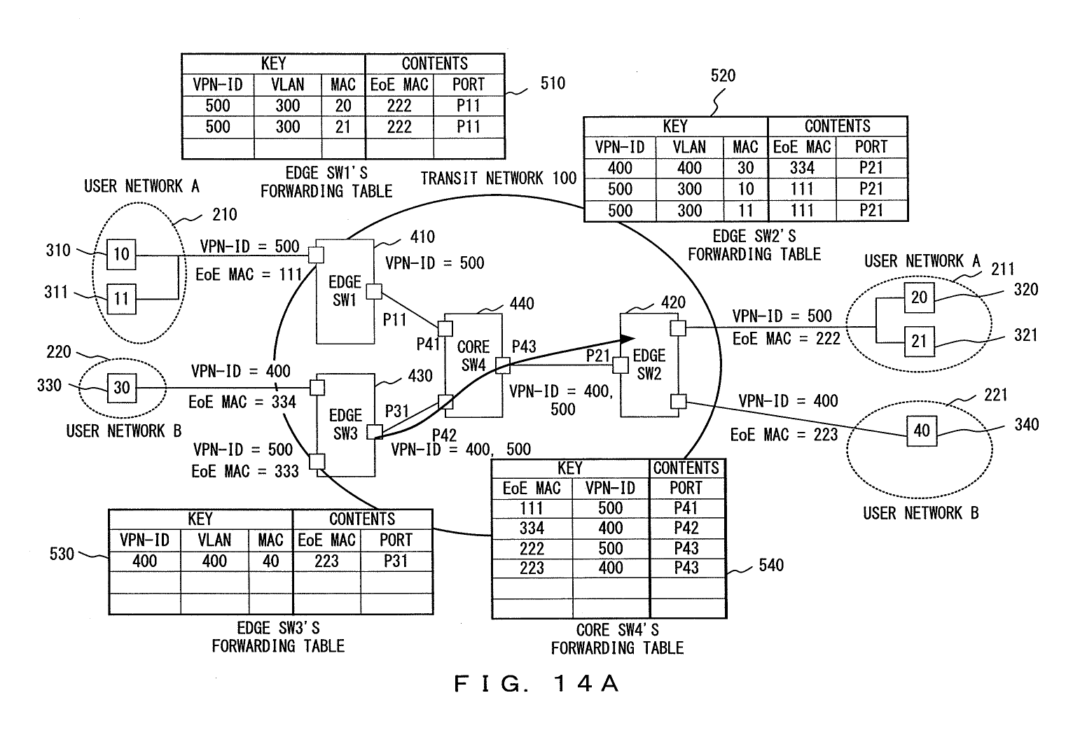

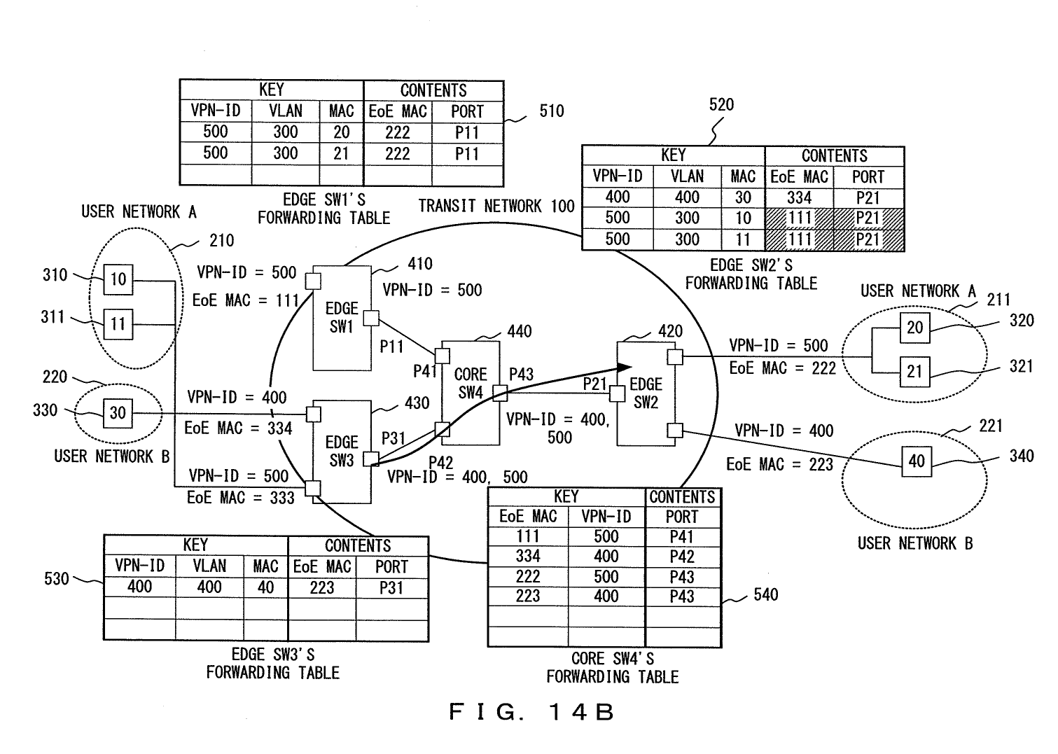

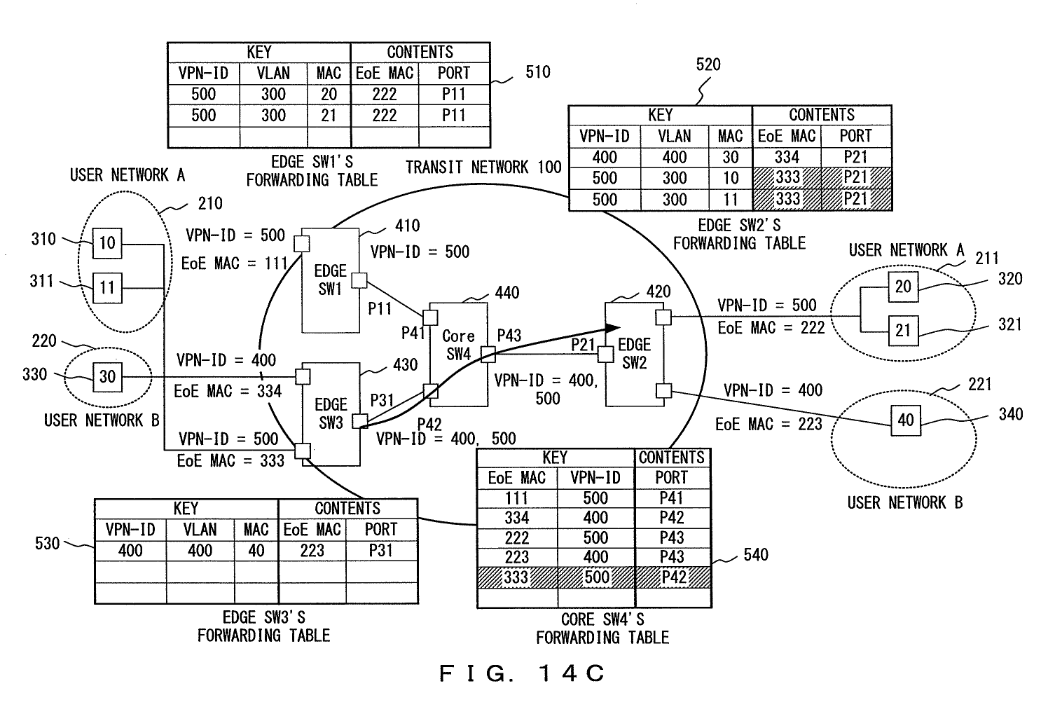

FIG. 14A illustrates an example of the configuration of the network using switches according to an embodiment.

A transit network 100 is configured to include an edge switch (1) 410 (referred to as “edge SW1” in the drawings), an edge switch (2) 420 (referred to as “edge SW2” in the drawings), an edge switch (3) 430 (referred to as “edge SW3” in the drawings), and a core switch (4) 440 (referred to as “core SW4” in the drawings).

The edge switch (1) 410 accommodates a user network (A) 210, the edge switch (2) 420 accommodates a user network (A) 211 and a user network (B) 221, and the edge switch (3) 430 accommodates a user network (B) 220.

The user network (A) 210 includes devices 310 and 311 respectively having MAC addresses “10” and “11”. The devices 310 and 311 are connected to an access port to which the EoE MAC address “111” is assigned and which is of the edge switch (1) 410 in the transit network 100. The user network (A) 211 includes devices 320 and 321 respectively having MAC addresses “20” and “21”. The devices 320 and 321 are connected an access port to which the EoE MAC address “222” is assigned and which is of the edge switch (2) 420 in the transit network 100.

These devices belong to the same VLAN (to which “300” is assigned as the VLAN value) in the user networks (A) 210 and 211, and frames are transmitted and received between the devices through the transit network 100.

The frames transmitted and received between the devices belonging to the VLAN identified by the VLAN value “300” in the user networks (A) 210 and 211 are managed by the VPN-ID “500” in the transit network 100.

Similarly, a device 330 having a MAC address “30” is provided in the user network (B) 220, and a device 340 having a MAC address “40” is provided in the user network (B) 221. The devices 330 and 340 transmit and receive frames through the transit network 100. These devices belong to the VLAN identified by a VLAN value “400” in the user networks (B) 220 and 221.

The device 330 having the MAC address “30” is connected to an access port to which an EoE MAC address “334” is assigned and which is of the edge switch (3) 430 in the transit network 100. The device 340 having the MAC address “40” is connected to an access port to which an EoE MAC address “223” is assigned and which is of the edge switch (2) 420 in the transit network 100.

The frames transmitted and received between the devices belonging to the VLAN identified by the VLAN value “400” in the user networks (B) 220 and 221 are managed by the VPN-ID “400” in the transit network 100.

In the memory in each removable communication module connected to each access port of each edge switch, the value equal to the EoE MAC address assigned to the access port is written as an identification number of the communication module. That is, “111” is written to the communication module that is connected to the access port of the edge switch (1) 410 and that is for the user network (A) 210 to which the device 310 having the MAC address “10” and the device 311 having the MAC address “11” belong. Similarly, the values respectively equal to the EoE MAC addresses assigned to respective access ports are written into other communication modules, respectively.

In addition, a pair of access ports configuring a redundant system is set in each edge switch. For example, it is set in the edge switch (1) 410 that its access port identified by EoE MAC=“111” configures a redundant system with an access port which is identified by EoE MAC=“333” and which is of the edge switch (3) 430. Similarly, it is set in the edge switch (3) 430 that its access port identified by EoE MAC=“333” configures the redundant system with the access port which is identified by EoE MAC=“111” and which is of the edge switch (1) 410.

It is configured so that the port P41 of the core switch (4) 440 transmits and receives frames belonging to the VPN identified by the VPN-ID “500”, and so that the ports P42 and P43 of the core switch (4) 440 transmit and receive frames belonging to the VPNs identified by the VPN-IDs “400” and “500”.

The contents of the forwarding table of each edge switch and core switch during the transmission and reception of frames between user networks are illustrated in FIG. 14A.

A forwarding table 510 of the edge switch (1) 410 contains two entries corresponding to the devices 320 and 321 belonging to the user network (A) 211. In the key portion, each VPN-ID is “500” and each VLAN value is “300”. As the respective MAC addresses, “20” and “21” respectively being the MAC addresses of the devices 320 and 321 are stored. In the contents portion of each entry, “222” assigned to the access port accommodating the user network (A) 211 is specified as the EoE MAC address, and the network port P11 of the edge switch (1) 410 is specified as the port.

A forwarding table 520 of the edge switch (2) 420 contains three entries corresponding to the devices 310 and 311 belonging to the user network (A) 210, and the device 330 belonging to the user network (B) 220.

The entry corresponding to the device 310 has the values “500” for the VPN-ID, “300” for the VLAN value, “10” for the MAC address, “111” for the EoE MAC address, and “P21” for the port.

The entry corresponding to the device 311 has the values “500” for the VPN-ID, “300” for the VLAN value, “11” for the MAC address, “111” for the EoE MAC address, and “P21” for the port.

The entry corresponding to the device 330 has the values “400” for the VPN-ID, “400” for the VLAN value, “30” for the MAC address, “334” for the EoE MAC address, and “P21” for the port.

There is only one entry in a forwarding table 530 of the edge switch (3) 430 corresponding to the device 340 belonging to the user network (B) 221. The entry has the values “400” for the VPN-ID, “400” for the VLAN value, “40” for the MAC address, “223” for the EoE MAC address, and “P31” for the port.

An output port can be retrieved from a forwarding table 540 of the core switch (4) 440 using an EoE MAC address of a forwarding destination and a VPN-ID. The forwarding table 540 includes entries as many as the number of access ports to which user networks are respectively connected.

The contents of respective entries are as follows: the port “P41” is stored for the EoE MAC address “111” and the VPN-ID “500”; the port “P42” is stored for the EoE MAC address “334” and the VPN-ID “400”; the port “P43” is stored for the EoE MAC address “222” and the VPN-ID “500”; and the port “P43” is stored for the EoE MAC address “223” and the VPN-ID “400”.

FIG. 14B illustrates the configuration after a switchover of a user network in an example of the network configuration illustrated in FIG. 14A.

It is assumed that it is necessary to perform the maintenance of the edge switch (1) 410 during the operation according to the settings illustrated in FIG. 14A. As illustrated in FIG. 14B, it is also assumed that, based on the above-mentioned pairing for the redundant system, the connection between the user network (A) 210 and the access port which is identified by the EoE MAC=“111” and which is of the edge switch (1) 410 is changed into the connection between the user network (A) 210 and the access port which is identified by the EoE MAC=“333” and which is of the edge switch (3) 430.

In the forwarding table 520 of the edge switch (2) 420, it has been learned that the devices 310 and 311 respectively having the MAC addresses “10” and “11” exist beyond the access port identified by the EoE MAC=“111”. In the forwarding table 540 of the core switch (4) 440, it has been learned that the access port identified by EoE MAC=“111” exists beyond the port P41.

If the forwarding tables were left as they were after the above-mentioned switchover, a frame addressed to the device 310 or 311, which has the MAC address “10” or “11”, respectively, and is in the user network (A) 210, would be forwarded to the edge switch (1) 410 upon being output from the network port P21 of the edge switch (2) 420 until re-learning were performed, and the frame would not be forwarded to the edge switch (3) 430 intended as the forwarding destination.

On the other hand, according to the present embodiment, if a communication module that had been connected to the edge switch (1) 410 is connected to the edge switch (3) 430, the edge switch (3) 430 detects a connection of the communication module, and compares the EoE MAC address assigned to the connected access port with the EoE MAC address recorded in the memory in the communication module.

In the example illustrated in FIG. 14B, the EoE MAC address assigned to the access port is “333”, and the EoE MAC address recorded in the communication module is “111”. Accordingly, it is detected that they do not match each other. In addition, the EoE MAC=“111” recorded in the communication module is the identification number of the counterpart access port that is paired with the access port identified by the EoE MAC=“333” to form a redundant system. Therefore, the edge switch (3) 430 transmits a control multicast frame for rewriting entries in the forwarding tables to the transit network 100.

The control multicast frame has EoE MAC=“333” as the source address, and EoE MAC=“111” is set in the payload of the control multicast frame as the EoE MAC address to be rewritten. The control multicast frame is transmitted and received at the ports to which VPN-ID “500” is assigned in the transit network 100.

The control multicast frame output from the network port P31 of the edge switch (3) 430 is received at the port P42 of the core switch (4) 440. The core switch (4) 440 forwards the control multicast frame to the switch at the subsequent stage. The source MAC address of the control multicast frame is learned as with a normal frame. That is, it is set so that a frame having the destination EoE MAC address=“333” is transmitted to the port P42. The entry having EoE MAC=“111” and the destination port=“P41” is left as is, and erased with the lapse of aging time.

The control multicast frame output from the port P43 of the core switch (4) 440 is input to the network port P21 of the edge switch (2) 420. Triggered by receipt of the control multicast frame, the edge switch (2) 420 searches the forwarding table 520 in the edge switch (2) 420 for the entry having EoE MAC=“111” in the contents. Upon detection of the entry, the EoE MAC is rewritten from “111” to “333”, and the port in the contents portion is rewritten into the network port P21 at which the control multicast frame has been received (in the example, the value of the port is “P21” after the rewriting as before). The diagonally shaded area in the forwarding table 520 is to be rewritten.

Although not illustrated in the attached drawings, a control multicast frame is also output from the port P41 of the core switch (4) 440, and input to the network port P11 of the edge switch (1) 410. However, since there is no entry having EoE MAC=“111” in the forwarding table 510 of the edge switch (1) 410, no rewriting is performed.

FIG. 14C illustrates a result of rewriting each forwarding table triggered by the switchover of the user network illustrated in FIG. 14B.

In the FIG. 14C, the diagonally shaded areas are changed portions, and indicate that the forwarding table 520 of the edge switch (2) 420 is rewritten, and that an entry is added to the forwarding table 540 of the core switch (4) 440 as a result of learning.

After the forwarding tables 520 and 540 are rewritten as above, a frame addressed to the MAC address “10” or “11” output from the device 320 or 321, which has the MAC address “20” or “21” and which is in the user network (A) 211, is transformed by the edge switch (2) 420 to be an EoE frame in which EoE MAC=“333” as the destination address and “500” as the VPN-ID value are set on the basis of the rewritten forwarding table 520. The EoE frame is forwarded from the network port P21 of the edge switch (2) 420 to the port P43 of the core switch (4) 440.

The core switch (4) 440 finds the port P42 by searching the forwarding table 540 using EoE MAC=“333” and VPN-ID=“500”, and forwards the EoE frame from the port P42 to the edge switch (3) 430.

Upon arrival at the edge switch (3) 430, the header portion having been added for the EoE is deleted from the EoE frame in order to restore the original user frame; and the restored original user frame is forwarded from the access port identified by EoE MAC=“333” to the user network (A) 210.

The embodiments had been described above in detail with reference to the EoE system. However, it is obvious from the descriptions above that the embodiments are not limited to be applied to the EoE system, but can be applied to another system so far as the edge switch accommodating a user network forwards a communication frame from the user network to a wide area network using a table for which the correspondence between the port provided at the WAN-side and the destination address has been learned.

Finally, the above-mentioned embodiments are explained from the viewpoint of their advantageous effects.

Some technologies enable a learning table to be automatically set in response to a switchover. However, they may not directly issue a notification that a switchover has occurred from a switch where the switchover has occurred. They may determine whether or not a switchover has occurred, or may determine whether or not the necessity of a switchover arises, by performing a monitoring operation at predetermined time intervals. According to such technologies, an extra load is imposed on a wide area network. In addition, it is hard to determine an appropriate interval of the monitoring operation.

Then, it can be considered to directly notify other switches in the network of a switchover when the switchover is made. Note that a switchover is made by a human maintainer, who might err in switching-over operation. Thus, if a connection error arises, an automatic setting after the connection will destroy the learned contents in the network.

Therefore, the above embodiments aim at automatically, and without an extra load on a wide area network, erasing or rewriting learned contents when a switchover between access ports of an edge switch (or edge switches) is occurred. The above embodiments also aim at preventing the adverse influence of a connection error caused by a maintainer on a network.

Accordingly, in the above embodiments, the identification number of a connected access port is stored in a storage unit provided for a communication module configured to connect a user network to the access port of an edge switch.

An edge switch according to an aspect of the above embodiments includes: an identification number storage unit configured to store the identification number assigned to an access port; a detecting unit configured to detect a connection of the communication module to the access port; a switchover determination unit configured to read the identification number recorded in the storage unit of the connected communication module, to compare the read identification number with the identification number of the access port to which the communication module has just been connected, and to determine whether or not a switchover of the user network has occurred; and an identification number writing unit configured to write to the storage unit of the communication module the identification number of the access port to which the communication module has just been connected.

The edge switch may notify another switch in a wide area network that the access port identified by the identification number having been recorded in the storage unit of the communication module is not used any more.

The edge switch may also notify another switch in a wide area network of the identification number of the access port to which the communication module has just been connected in switching-over.

Therefore, according to the above embodiment, the learned contents of a forwarding table can be immediately erased or rewritten when the accommodation of a user network is changed. In addition, when the forwarding table is rewritten, frames can be forwarded without flooding (i.e., without broadcasting) even after the accommodation is changed. Thus, the consumption of the communication band caused by the flooding can be reduced.

In addition, the above-mentioned operations can be automatically performed by the software in a device triggered by a switchover operation by a maintainer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An edge switch that switches a communication frame between a user network and a wide area network, the edge switch comprising:
an access port configured to connect a communication module that is of the user network and that includes a storage unit configured to store a first identification number identifying which access port the communication module is connected to;
a first identification number storage unit configured to store a second identification number assigned to the access port;
a control circuit for the access port that includes a detecting unit configured to detect a connection of the communication module to the access port;
an identification number reading unit configured to read the first identification number recorded in the storage unit of the communication module upon the control circuit detecting the connection of the communication module to the access port;
a switchover determination unit configured
to read from the first identification number storage unit the second identification number of the access port to which the connection of the communication module has been detected,
to compare the second identification number with the first identification number read by the identification number reading unit, and
to determine that a switchover of the communication module has occurred if the compared first and second identification numbers do not match each other; and
an identification number writing unit configured to write to the storage unit of the communication module the second identification number read from the first identification number storage unit when the switchover determination unit determines that the switchover of the communication module has occurred.

2. The edge switch according to claim 1, wherein
the control circuit notifies the identification number reading unit of detection of the connection of the communication module to the access port.

3. The edge switch according to claim 1, wherein
the control circuit includes a first detection status holding unit configured to hold a first detection status indicating whether or not the connection of the communication module to the access port is detected; and
the identification number reading unit periodically reads the first detection status from the first detection status holding unit.

4. The edge switch according to claim 1, wherein
the control circuit includes the first identification number storage unit, the identification number reading unit, the switchover determination unit, and the identification number writing unit.

5. The edge switch according to claim 4, further comprising
a central processing unit, wherein
the control circuit notifies the central processing unit that the switchover of the communication module has occurred when the switchover determination unit determines that the switchover of the communication module has occurred.

6. The edge switch according to claim 5, wherein:
the control circuit includes a second identification number storage unit configured to store a third identification number assigned to an access port of a counterpart edge switch with which the edge switch forms a redundant system;
the switchover determination unit
compares the first identification number with the second identification number,
further reads the third identification number from the second identification number storage unit and compares the read third identification number with the first identification number if the compared first and second identification numbers do not match each other, and
determines that the switchover of the communication module has occurred if the compared third and first identification numbers match each other.

7. The edge switch according to claim 6, wherein
the switchover determination unit
reads the third identification number from the second identification number storage unit and compares the read third identification number with the first identification number, and
determines that a connection error has occurred if the compared third and first identification numbers do not match each other; and
the control circuit notifies the central processing unit that the connection error has occurred if the switchover determination unit determines that the connection error has occurred.

8. The edge switch according to claim 4, further comprising
a central processing unit, wherein:
the control circuit includes a first detection status holding unit configured to hold a first detection status indicating whether or not the switchover determination unit has detected the switchover of the communication module;
the central processing unit periodically reads the first detection status from the first detection status holding unit.

9. The edge switch according to claim 8, wherein:
the control circuit includes a second identification number storage unit configured to store a third identification number assigned to an access port of a counterpart edge switch with which the edge switch forms a redundant system;
the switchover determination unit
compares the first identification number with the second identification number,
further reads the third identification number from the second identification number storage unit and compares the read third identification number with the first identification number if the compared first and second identification numbers do not match each other, and
determines that the switchover of the communication module has occurred if the compared third and first identification numbers match each other.

10. The edge switch according to claim 9, wherein
the switchover determination unit
reads the third identification number from the second identification number storage unit and compares the read third identification number with the first identification number, and
determines that a connection error has occurred if the compared third and first identification numbers do not match each other; and
the control circuit includes a second detection status holding unit configured to hold a second detection status indicating whether or not the connection error is determined to have occurred;
the central processing unit periodically reads the second detection status from the second detection status holding unit.

11. The control circuit used in the edge switch according to claim 1.

12. The edge switch according to claim 1, wherein
when the switchover determination unit determines that the switchover of the communication module has occurred, the edge switch transmits a message that includes the first identification number and that notifies an occurrence of the switchover of the communication module to another edge switch through a control network configured to connect between the edge switches in the wide area network.

13. The edge switch according to claim 1, wherein
when the switchover determination unit determines that the switchover of the communication module has occurred, the edge switch transmits a control multicast frame that includes the first identification number and that notifies an occurrence of the switchover of the communication module to another edge switch through the wide area network.

14. The edge switch according to claim 13, wherein
the control multicast frame further includes the second identification number assigned to the access port to which the communication module is connected.

15. A forwarding table rewriting method, wherein:
the wide area network includes the edge switch according to claim 12 as a first edge switch, a second edge switch, and a control network configured to connect between the first and second edge switches;
each of the first and second edge switches switches a communication frame between each user network and the wide area network using a forwarding table;
the forwarding table stores a correspondence between a destination of the communication frame and a network port towards the wide area network to transmit the communication frame; and
the forwarding table rewriting method includes:
transmitting, by the first edge switch, upon detection of the switchover of the communication module, the message to the second edge switch through the control network,
searching, by the second edge switch, upon receipt of the message, the forwarding table of the second edge switch by the first identification number included in the message, and
deleting, by the second edge switch, an entry including the first identification number from the forwarding table of the second edge switch.

16. A forwarding table rewriting method, wherein:
the wide area network includes the edge switch according to claim 13 as a first edge switch, and includes a second edge switch;
each of the first and second edge switches switches a communication frame between each user network and the wide area network using a forwarding table;
the forwarding table stores a correspondence between a destination of the communication frame and a network port towards the wide area network to transmit the communication frame; and
the forwarding table rewriting method includes:
transmitting, by the first edge switch, upon detection of the switchover of the communication module, the control multicast frame to the wide area network,
searching, by a second edge switch, upon receipt of the control multicast frame, the forwarding table of the second edge switch by the first identification number included in the control multicast frame, and
deleting, by the second edge switch, an entry including the first identification number from the forwarding table of the second edge switch.

17. A forwarding table rewriting method, wherein:
the wide area network includes the edge switch according to claim 14 as a first edge switch, and includes a second edge switch;
each of the first and second edge switches switches a communication frame between each user network and the wide area network using a forwarding table;
the forwarding table stores a correspondence between a destination of the communication frame and a network port towards the wide area network to transmit the communication frame; and
the forwarding table rewriting method includes:
transmitting, by the first edge switch, upon detection of the switchover of the communication module, the control multicast frame to the wide area network; and
searching, by the second edge switch, upon receipt of the control multicast frame, the forwarding table of the second edge switch by the first identification number; and
rewriting, by the second edge switch, in an entry found in the searching, the first identification number to the second identification number of the access port.
